(19) United States
(12) Patent Application Publication
(10) Pub. No.: US 2010/0262998 A1
(43) Pub. Date: Oct. 14, 2010

(54) RECORDING RESERVATION REGISTRATION SYSTEM, RECORDING RESERVATION REGISTRATION APPARATUS, RECORDING RESERVATION REGISTRATION METHOD, PROGRAM, AND RECORDING MEDIUM

(76) Inventor: Toshiki Yamamura, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/681,832

(22) PCT Filed: Dec. 1, 2009
(86) PCT No.: PCT/JP2009/006499

§ 371 Date: Apr. 6, 2010

(30) Foreign Application Priority Data
Dec. 4, 2008 (JP) 2008-310053 2008

(51) Int. Cl. H04N 5/445

(52) U.S. Cl. 725/58

(57) ABSTRACT

Provided is a recording reservation registration apparatus that transmits a recording reservation registration request to a recordable recording apparatus which sets a recording reservation in accordance with the received recording reservation registration request, the recording reservation registration apparatus including: a reservation information input unit; a control unit that generates a recording reservation registration request; and a reservation information transmitting unit that transmits the generated recording reservation registration request. The control unit compares a zone of time specified by the inputted recording reservation information and a possible time limit of recording reservation setting of the recording apparatus, holds the recording reservation information until the recording reservation can be set in the recording apparatus if the recording reservation cannot be set in the recording apparatus, and generates the recording reservation registration request from the held recording reservation information when the recording reservation becomes capable to be set.

### TECHNICAL FIELD

The present invention relates to a recording reservation registration system, a recording reservation registration apparatus, a recording reservation registration method, and the like. For example, the present invention relates to a recording reservation registration system, a recording reservation registration apparatus, a recording reservation registration method, and the like constituted by a recording reservation registration apparatus that requests a recording apparatus for recording reservation registration based on program information of a selected program and a recording apparatus that sets a recording reservation in accordance with the recording reservation registration request from the recording reservation registration apparatus to execute the reservation recording.

### BACKGROUND ART

A technique for controlling other AV (audio visual) devices is widely used, in which, for example, the AV devices at home are connected to each other through a network, and contents are shared between the AV devices. For example, there is a recording reservation registration system for remotely registering a recording reservation, in which a recording reservation registration apparatus, such as a PC and a TV, transmits a recording reservation registration request to a recording apparatus, such as an HDD recorder.

FIG. 16 shows an example of a processing flow during recording reservation registration of such a conventional recording reservation registration system. Here, an example is illustrated, in which a digital television (DTV) 100 registers a recording reservation of a digital video recorder (DVR) 101 connected through a network.

First, information to be reserved and registered (recording reservation information) in the DVR 101 is inputted and determined in the DTV 100 as a recording reservation registration apparatus (step S100). The user displays the program information acquired by the DTV 100 on a screen and operates a remote controller 102 accompanying the DTV 100 to select a program that the user desires to reserve recording. Based on the program information of the selected program, a recording mode desired by the user, and the like, the DTV 100 generates a recording reservation registration request 103 including parameters necessary to reserve recording and transmits the recording reservation registration request 103 to the DVR 101 through the network.

The DVR 101 determines availability to reserve recording based on the received recording reservation registration request 103, information held by the DVR 101, and the recording reservation capability of the DVR 101 (step S110). If recording can be reserved, the DVR 101 sets the recording reservation (step S111) and returns a response 104 to the DTV 100, the response indicating that the recording reservation setting is completed. If the DVR 101 determines that recording cannot be reserved in step S110, the DVR 101 does not execute the recording reservation setting process (step S111) and returns the response 104 to the DTV 100, the response indicating that the recording reservation setting is impossible.

When the response (registration result) 104 is received from the DVR 101, the DTV 100 displays the reservation registration result in the DVR 101 on the screen, and the user can recognize the reservation registration result (step S101).

In this way, the recording reservation setting process from the recording reservation registration apparatus connected through the network to the recording apparatus is realized.

### SUMMARY OF THE INVENTION

### Problems to be Solved by the Invention

However, in the conventional recording reservation registration system, the recording reservation cannot be set to the recording apparatus when recording reservation information, which designates a program or a time later than the time limit that allows setting the recording reservation in the recording apparatus, is inputted to the recording reservation registration apparatus.

The problem will be specifically described below.

The recording apparatus usually has a time limit that allows setting the recording reservation for each recording reservation type, such as, for example, until one month later for time designation reservation in which only the start date/time or the recording time is designated and until one week later that allows acquiring program information in the case of program reservation in which a program identifier included in the broadcast is designated to execute reservation recording in accordance with the program. Therefore, if the content of the recording reservation information inputted in the recording reservation registration apparatus designates a program or a time later than the time limit that allows setting the recording reservation in the recording apparatus, setting of the recording reservation fails in the recording apparatus.

FIG. 17 shows a relationship between the time limit that allows setting the recording reservation in the recording apparatus and the recording reservation request period inputted in the recording reservation registration apparatus. FIG. 17 shows an example of the time limit that allows setting the recording reservation by program reservation, and in this case, only a recording reservation from now to eight days later can be set in the recording apparatus. On the other hand, in the recording reservation registration apparatus, it is assumed that program information can be referenced up to the date/time later than the date/time that the recording apparatus can reference and that reservation setting of a program in a zone of time in a period (for example, period from now to thirty days later) later than the period (until eight days later) that allows setting the recording reservation in the recording apparatus can be inputted.

In this case, for example, if recording reservation information specifying a recording reservation request period A is inputted in the recording reservation registration apparatus, the recording reservation request period A is in a zone of time three days later from now and is in a zone of time within the recording reservation setting possible period of the recording apparatus. Therefore, the recording reservation is set in the recording apparatus. However, if recording reservation information specifying a recording reservation request period B is inputted in the recording reservation registration apparatus, the recording reservation request period B is in a zone of time ten days later from now and is a period that recording reservation of the recording apparatus cannot be set. Therefore, the recording reservation cannot be set, and a notification “recording reservation cannot be set” is returned to the recording reservation registration apparatus. Therefore, the input process of the recording reservation cannot be completed when the user wants to register the recording reservation if the recording reservation request period B is designated.

As a result, in order for the user to reserve recording of a program in the recording reservation request period. B, it is inconvenient that the user has to wait until the recording reservation request period B is in a zone of time before the recording reservation setting possible time limit 105 of the recording apparatus to again input the recording reservation information.

In consideration of the conventional problems, an object of the present invention is to provide a recording reservation registration system, recording reservation registration apparatus, a recording reservation registration method, and the like that can reserve recording beyond a recording reservation setting possible time limit of a recording apparatus.

To solve the above-described problems,

the 1^{st} aspect of the present invention is a recording reservation registration system comprising:

a recording reservation registration apparatus that transmits a recording reservation registration request of a program to be broadcasted; and

a recordable recording apparatus that receives the recording reservation registration request to set a recording reservation in accordance with the recording reservation registration request,

the recording reservation registration apparatus comprising:

a reservation information input unit that inputs recording reservation information of a program to be reserved for recording into the recording apparatus;

a control unit that compares a zone of time specified by the inputted recording reservation information and a possible time limit of recording reservation setting of the recording apparatus, generates the recording reservation registration request from the recording reservation information when the recording reservation can be set in the recording apparatus, holds the recording reservation information until the recording reservation can be set in the recording apparatus when the recording reservation cannot be set in the recording apparatus, and generates the recording reservation registration request from the held recording reservation information when the recording reservation becomes capable to be set in the recording apparatus; and

a reservation information transmitting unit that transmits the recording reservation registration request generated by the control unit to the recording apparatus.

The

2^{nd} aspect of the present invention is a recording reservation registration apparatus that transmits a recording reservation registration request to a recordable recording apparatus which receives the recording reservation registration request of a program to be broadcasted and sets a recording reservation in accordance with the recording reservation registration request,

the recording reservation registration apparatus comprising:

a reservation information input unit that inputs recording reservation information of a program to be reserved for recording into the recording apparatus;

a control unit that compares a zone of time specified by the inputted recording reservation information and a possible time limit of recording reservation setting of the recording apparatus, generates the recording reservation registration request from the recording reservation information when the recording reservation can be set in the recording apparatus, holds the recording reservation information until the recording reservation can be set in the recording apparatus when the recording reservation cannot be set in the recording apparatus, and generates the recording reservation registration request from the held recording reservation information when the recording reservation becomes capable to be set in the recording apparatus; and

a reservation information transmitting unit that transmits the recording reservation registration request generated by the control unit to the recording apparatus.

The 3rd aspect of the present invention is a recording reservation registration system comprising:

a recording reservation registration apparatus that transmits a recording reservation registration request of a program to be broadcasted; and

a recordable recording apparatus that receives the recording reservation registration request to set a recording reservation in accordance with the recording reservation registration request, wherein

there are two types of the recording reservations, and possible time limits of recording reservation setting of the recording reservations are different to each other,

the recording reservation registration apparatus comprising:

a reservation information input unit that inputs recording reservation information including information of a recording reservation type, of a program to be reserved for recording into the recording apparatus;

a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generates a recording reservation registration request corresponding to the different recording reservation type from the inputted recording reservation information when the recording reservation can be set by the different recording reservation type in the recording apparatus; and

a reservation information transmitting unit that transmits the recording reservation registration request generated by the control unit to the recording apparatus.

The 4^{th} aspect of the present invention is a recording reservation registration apparatus that transmits a recording reservation registration request to a recordable recording apparatus which receives the recording reservation registration request of a program to be broadcasted and sets a recording reservation in accordance with the recording reservation registration request, wherein

there are two types of the recording reservations, and possible time limits of recording reservation setting of the recording reservations are different to each other,

the recording reservation registration apparatus comprising:

a reservation information input unit that inputs recording reservation information including information of a recording reservation type, of a program to be reserved for recording into the recording apparatus;

a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generates a recording reservation registration request corresponding to the different recording reservation type from the inputted recording reservation information when the recording reservation can be set by the different recording reservation type in the recording apparatus; and

a reservation information transmitting unit that transmits the recording reservation registration request generated by the control unit to the recording apparatus.

The 5^{th} aspect of the present invention is the recording reservation registration apparatus according to the 4^{th} aspect of the present invention, wherein

the control unit holds the inputted recording reservation information until the recording reservation can be set by the recording reservation type with a longer period until possible time limit in the recording apparatus when the recording reservation cannot be set by the different recording reservation type in the recording apparatus and generates a recording reservation registration request corresponding to the recording reservation type with the longer period until possible time limit from the held recording reservation information when the recording reservation becomes capable to be set.

The 6^{th} aspect of the present invention is the recording reservation registration apparatus according to the 5^{th} aspect of the present invention, wherein

when the recording reservation type with the period until longer possible time limit is not the recording reservation type of the inputted recording reservation information, after generating the recording reservation registration request corresponding to the recording reservation type with the longer period until possible time limit, the control unit generates a recording reservation registration request corresponding to the recording reservation type of the inputted recording reservation information and a cancellation instruction of the recording reservation set by the recording reservation registration request of the recording reservation type with the longer period until possible time limit when the recording reservation becomes capable to be set by the recording reservation type with a shorter period until possible time limit, and

the reservation information transmitting unit transmits, to the recording apparatus, the cancellation instruction of the recording reservation generated by the control unit and the recording reservation registration request corresponding to the recording reservation type of the inputted recording reservation information.

The 7^{th} aspect of the present invention is a recording reservation registration system comprising:

a recording reservation registration apparatus that transmits a recording reservation registration request of a program to be broadcasted; and

a recordable recording apparatus that receives the recording reservation registration request to set a recording reservation in accordance with the recording reservation registration request, wherein

there are two types of the recording reservations, and possible time limits of recording reservation setting of the recording reservations are different to each other,

the recording reservation registration apparatus comprising:

a reservation information input unit that inputs recording reservation information including information of a recording reservation type, of a program to be reserved for recording into the recording apparatus;

a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generates a recording reservation registration request corresponding to the different recording reservation type from the inputted recording reservation information when the recording reservation can be set by the different recording reservation type in the recording apparatus; and

a reservation information transmitting unit that transmits the recording reservation registration request generated by the control unit to the recording apparatus.

The 8^{th} aspect of the present invention is a recording reservation registration apparatus that transmits a recording reservation registration request to a recordable recording apparatus which receives the recording reservation registration request of a program to be broadcasted and sets a recording reservation in accordance with the recording reservation registration request, wherein

there are two types of the recording reservations, and possible time limits of recording reservation setting of the recording reservations are different to each other,

the recording reservation registration apparatus comprising:

a reservation information input unit that inputs recording reservation information including information of a recording reservation type, of a program to be reserved for recording into the recording apparatus;

a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generates a recording reservation registration request corresponding to the different recording reservation type from the inputted recording reservation information when the recording reservation can be set by the different recording reservation type in the recording apparatus; and

a reservation information transmitting unit that transmits the recording reservation registration request generated by the control unit to the recording apparatus.

The 9^{th} aspect of the present invention is the recording reservation registration apparatus according to the 4^{th} or the 8^{th} aspect of the present invention, wherein

the control unit holds the inputted recording reservation information until the recording reservation can be set in the recording apparatus by the recording reservation type of the inputted recording reservation information when the recording reservation cannot be set by the different recording reservation type in the recording apparatus and generates a recording reservation registration request corresponding to the recording reservation type of the held recording reservation information when the recording reservation becomes capable to be set.

The 10^{th} aspect of the present invention is the recording reservation registration apparatus according to the 4^{th} or the 8^{th} aspect of the present invention, wherein

the two types of recording reservations include time designation reservation set by a zone of time with an absolute time and program reservation set based on a program identifier included in program information, and

when generating a recording reservation registration request corresponding to the program reservation from the recording reservation information inputted by the time designation reservation, the control unit generates the recording reservation registration request corresponding to one or a plurality of consecutive programs including the zone of time specified by the inputted recording reservation information.

The 11^{th} aspect of the present invention is the recording reservation registration apparatus according to the 8^{th} aspect of the present invention, wherein

the control unit holds the inputted recording reservation information until the recording reservation can be set in the recording apparatus by the recording reservation type of the inputted recording reservation information when the recording reservation cannot be set in the recording apparatus by the recording reservation type of the inputted recording reservation information and when the period until the possible time limit corresponding to the recording reservation type different from the recording reservation type of the recording reservation information is shorter than the period until the possible time limit of the recording reservation type of the recording reservation information and generates a recording reservation registration request corresponding to the recording reservation type of the held recording reservation information when the recording reservation becomes capable to be set.

The 12^{th} aspect of the present invention is the recording reservation registration apparatus according to the 8^{th} aspect of the present invention, wherein

the control unit holds the inputted recording reservation information until the recording reservation can be set by the different recording reservation type in the recording apparatus when the recording reservation cannot be set by the different recording reservation type in the recording apparatus and generates a recording reservation registration request corresponding to the different recording reservation type from the held recording reservation information when the recording reservation becomes capable to be set.

The 13^{th} aspect of the present invention is the recording reservation registration apparatus according to the 12^{th} aspect of the present invention, wherein

after generating the recording reservation registration request corresponding to the different recording reservation type, when the recording reservation becomes capable to be set by the recording reservation type of the inputted recording reservation information, the control unit generates a recording reservation registration request corresponding to the recording reservation type of the inputted recording reservation information and a cancellation instruction of the recording reservation set by the recording reservation registration request of the different recording reservation type, and

the reservation information transmitting unit transmits, to the recording apparatus, the cancellation instruction of the recording reservation generated by the control unit and the recording reservation registration request corresponding to the recording reservation type of the inputted recording reservation information.

The 14^{th} aspect of the present invention is the recording reservation registration apparatus according to any one of the 2^{nd}, the 4^{th}, the 8^{th} aspects of the present inventions, wherein

the zone of time specified by the recording reservation information is a zone of time determined by an absolute time or a zone of time determined by a program identifier included in program information, and

the possible time limit of recording reservation setting is defined as a time limit determined by an absolute time or a time limit determined by a relative time from when the recording apparatus receives the recording reservation registration request.

The 15^{th} aspect of the present invention is the recording reservation registration apparatus according to any one of the 2^{nd}, the 4^{th}, the 8^{th} aspects of the present inventions, comprising

a time limit information input unit for a user to input a possible time limit of recording reservation setting of the recording apparatus.

The 16^{th} aspect of the present invention is the recording reservation registration apparatus according to any one of the 2^{nd}, the 4^{th}, and the 8^{th} aspects of the present inventions, comprising

a time limit information receiving unit that acquires information of the possible time limit of recording reservation setting from the recording apparatus.

The 17^{th} aspect of the present invention is the recording reservation registration apparatus according to the 16^{th} aspect of the present invention, wherein

the time limit information receiving unit acquires the information of the possible time limit of recording reservation setting from the recording apparatus every time the zone of time specified by the inputted recording reservation information is compared or acquires the information from the recording apparatus in advance.

The 18^{th} aspect of the present invention is the recording reservation registration apparatus according to any one of the 2^{nd}, the 4^{th}, the 8^{th} aspects of the present inventions, comprising

a display unit that displays a processing result by the control unit.

The 19^{th} aspect of the present invention is a recording reservation registration method of a recording reservation registration apparatus that transmits a recording reservation registration request of a program to be broadcasted to a recordable recording apparatus that receives the recording reservation registration request to set a recording reservation in accordance with the recording reservation registration request,

the recording reservation registration method comprising:

a reservation information input step of inputting recording reservation information of a program to be reserved for recording into the recording apparatus;

a control step of comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus; and

a reservation information transmission step of transmitting the recording reservation registration request generated in the control step to the recording apparatus.

The 20^{th} aspect of the present invention is a recording reservation registration method of a recording reservation registration apparatus that transmits a recording reservation registration request of a program to be broadcasted to a recordable recording apparatus that receives the recording reservation registration request to set a recording reservation in accordance with the recording reservation registration request, wherein

there are two types of the recording reservations, and possible time limits of recording reservation setting of the recording reservations are different to each other,

the recording reservation registration method comprising:

a reservation information input step of inputting recording reservation information including information of a recording reservation type, of a program to be reserved for recording into the recording apparatus;

a control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus; and

a reservation information transmission step of transmitting the recording reservation registration request generated in the control step to the recording apparatus.

The 21^{st} aspect of the present invention is a recording reservation registration method of a recording reservation registration apparatus that transmits a recording reservation registration request of a program to be broadcasted to a recordable recording apparatus that receives the recording reservation registration request to set recording reservation in accordance with the recording reservation registration request, wherein

there are two types of the recording reservations, and possible time limits of recording reservation setting of the recording reservations are different to each other,

the recording reservation registration method comprising:

a reservation information input step of inputting recording reservation information including information of a recording reservation type, of a program to be reserved for recording into the recording apparatus;

a control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus; and

a reservation information transmission step of transmitting the recording reservation registration request generated in the control step to the recording apparatus.

The 22^{nd} aspect of the present invention is a program causing a computer to execute the control step of the recording reservation registration method according to the 19^{th} aspect of the present invention, the control step comprising comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus.

The 23^{rd} aspect of the present invention is a program causing a computer to execute the control step of the recording reservation registration method according to the 20^{th} aspect of the present invention, the control step comprising comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus.

The 24^{th} aspect of the present invention is a program causing a computer to execute the control step of the recording reservation registration method according to the 21^{st} aspect of the present invention, the control step comprising comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus.

The 25^{th} aspect of the present invention is a recording medium that can be processed by a computer, the recording medium recording the program according to any one of the 22^{nd} to the 24^{th} aspects of the present inventions.

### Advantage of the Invention

The present invention can provide a recording reservation registration system, a recording reservation registration apparatus, a recording reservation registration method, and the like that can reserve recording beyond a recording reservation setting possible time limit of the recording apparatus.

### BRIEF DESCRIPTION OF THE DRAWINGS

FIG. 1 is a block diagram of a recording reservation registration system of embodiments of the present invention;

FIG. 2 is a diagram showing a communication sequence when a recording reservation is set from a DTV to a DVR in the recording reservation registration system of a first embodiment of the present invention;

FIG. 3 is a diagram showing a processing flow of a recording reservation registration suspension transmission process in the DTV of the first embodiment of the present invention;

FIG. 4(a) is a diagram showing an example of a reservation possible date for each reservation type in the DVR of the embodiments of the present invention; FIG. 4(b) is a diagram showing an example of the reservation possible date for each reservation type in the DTV of the embodiments of the present invention;

FIG. 5 is a diagram showing an example of parameters included in a recording reservation registration request of the embodiments of the present invention;

FIG. 6 is a diagram showing an example of display displayed on a display when the user designates a zone of time beyond a recording reservation registration possible date of the DVR in the DTV of the first embodiment of the present invention;

FIG. 7 is a diagram showing a communication sequence when a recording reservation is set from the DTV to the DVR in the recording reservation registration system of a second embodiment of the present invention;

FIG. 8 is a diagram showing a processing flow of an alternative recording reservation registration process in the DTV of the second embodiment of the present invention;

FIG. 9 is a diagram showing an example of display displayed on a display when the user designates a zone of time beyond the recording reservation registration possible date of the DVR, and alternative reservation is performed, in the DTV of the second embodiment of the present invention;

FIG. 10 is a diagram showing a processing flow of another alternative recording reservation registration process in the DTV of the second embodiment of the present invention;

FIG. 11 is a diagram showing a communication sequence when the recording reservation is set from the DTV to the DVR in the recording reservation registration system of a third embodiment of the present invention;

FIG. 12 is a diagram showing a processing flow of a recording reservation registration alternative suspension transmission process in the DTV of the third embodiment of the present invention;

FIG. 13(a) is a diagram showing an example of display displayed on the display when the user designates a zone of time beyond the recording reservation possible date of the DVR, and the reservation setting is alternatively reserved, in the DTV of the third embodiment of the present invention; FIG. 13(b) is a diagram showing an example of display displayed on the display when the user designates a zone of time beyond the recording reservation possible date of the DVR, and the reservation registration is suspended, in the DTV of the third embodiment of the present invention;

FIG. 14 is a diagram showing a processing flow of another recording reservation registration alternative suspension transmission process in the DTV of the third embodiment of the present invention;

FIG. 15 is a diagram showing a communication sequence when the DTV sets a recording reservation and requests recording to the DVR in the recording reservation registration system comprising the DTV that transmits a recording request and program data in another embodiment of the present invention;

FIG. 16 is a diagram showing an example of a processing flow during recording reservation registration of a conventional recording reservation registration system; and

FIG. 17 is a diagram showing a relationship between a time limit that allows setting a recording reservation in a recording apparatus and a recording reservation request period inputted in a recording reservation registration apparatus in the conventional recording reservation registration system.

### MODES FOR CARRYING OUT THE INVENTION

Hereinafter, embodiments of the present invention will be described with reference to the drawings.

### First Embodiment

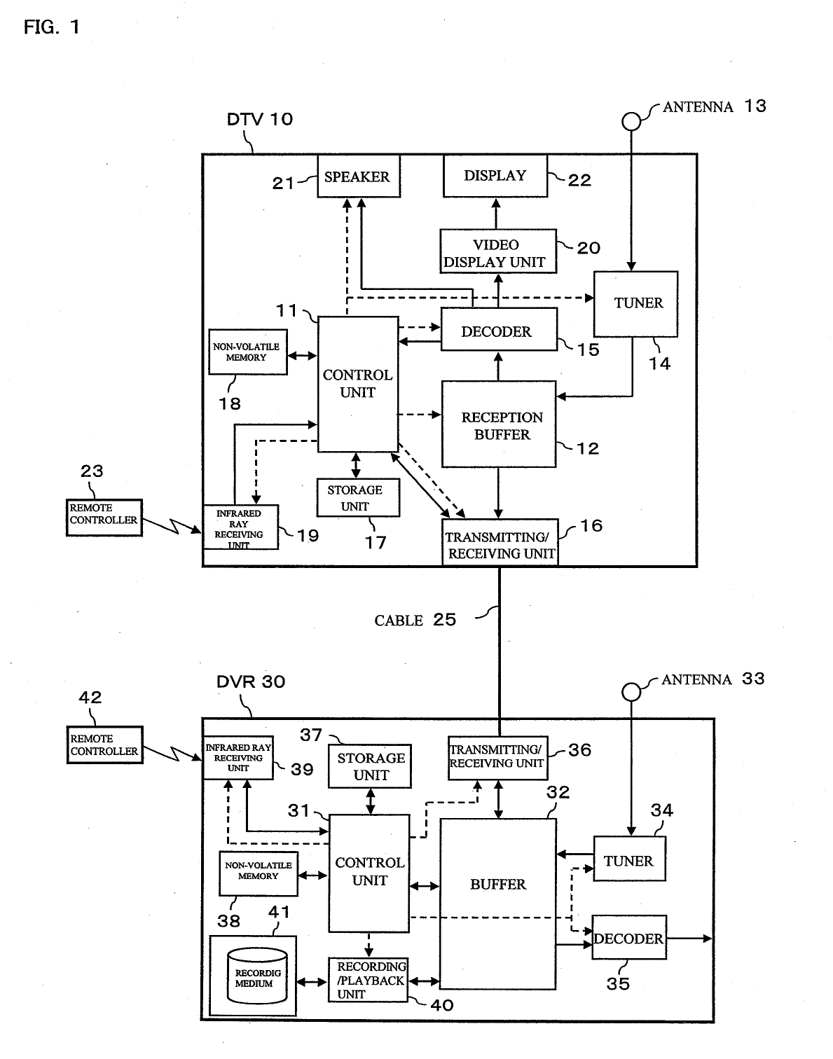

FIG. 1 shows a block diagram of a recording reservation registration system of a first embodiment of the present invention.

In FIG. 1, arrows indicated by solid lines show flows of data, and arrows indicated by broken lines show flows of control signals.

As for the recording reservation registration system of the present first embodiment, a digital television (DTV) 10 is connected to a digital video recorder (DVR) 30 by a cable 25.

The DTV 10 is an example of a recording reservation registration apparatus of the present invention, and the DVR 30 is an example of the recording apparatus of the present invention.

First, a configuration of the DTV 10 will be described.

A control unit 11 that controls the entire apparatus of the DTV 10 is constituted by a CPU. A storage unit 17 and a non-volatile memory 18 are connected to the control unit 11. The storage unit 17 is a RAM, and the non-volatile memory 18 is a ROM or a FLASH memory.

A tuner 14 as a broadcast receiving instrument connected with an antenna 13 for receiving broadcast selects a reception channel based on a control instruction from the control unit 11, and the reception output is, inputted to a decoder 15 as a signal processing instrument through a reception buffer 12. The control unit 11 controls the decoder 15 to decode the inputted data.

An audio signal decoded by the decoder 15 is outputted from a speaker 21 as an audio output instrument, and a decoded video signal is outputted from a video display unit 20 and displayed on a display 22.

An infrared ray receiving unit 19 as an operation input instrument is provided. When the user operates a remote controller 23 accompanying the DTV 10, the infrared ray receiving unit 19 receives an infrared ray emitted from the remote controller 23, and the user can provide an instruction of a control operation in the control unit 11. For example, the user can operate the remote controller 23 to provide an instruction to the control unit 11 to select a station.

The control unit 11 controls a transmitting/receiving unit 16 to transmit a request to the DVR 30 connected by the cable 25 and to receive a response from the DVR 30.

The storage unit 17 connected to the control unit 11 holds program information generated by the control unit 11 based on a transmission control signal PS1 and program sequence information SI that are received by the tuner 14 and in which the signal is processed by the decoder 15.

The program information is constituted by a program identifier (event ID), a start time of a program, an end time, and a title (program name), for each broadcast service (service ID) that can be received by the DTV 10. The DTV 10 uses the program information to create a program guide to guide the user for the programs. The program information is used as recording reservation registration parameters in reserving of recording of a program selected by the user.

The control unit 11 and the transmitting/receiving unit 16 of the DTV 10 are examples of a control unit and a reservation information transmitting unit of the present invention, respectively. The infrared ray receiving unit 19 that receives an infrared ray emitted from the remote controller 23 to accept an input by the user is an example of a reservation information input unit of the present invention.

Next, a configuration of the DVR 30 will be described.

A control unit 31 that controls the entire apparatus of the DVR 30 is constituted by a CPU. A storage unit 37 and a non-volatile memory 38 are connected to the control unit 31. The storage unit 37 is a RAM, and the non-volatile memory 38 is a ROM or a FLASH memory.

A tuner 34 as a broadcast receiving instrument connected with an antenna 33 for receiving broadcast selects a reception channel based on a control instruction from the control unit 31, and the reception output is inputted to a decoder 35 as a signal processing instrument through a buffer 32. The control unit 31 controls the decoder 35 to decode and output the inputted data.

An infrared ray receiving unit 39 is provided as an operation input instrument. When the user operates a remote controller 42 accompanying the DVR 30, the infrared ray receiving unit 39 receives an infrared ray emitted from the remote controller 42, and the user can provide an instruction of a control operation in the control unit 31. The user can also operate the remote controller 42 to provide an instruction of station selection or recording operation and provide an instruction of operation of reservation recording and the like.

A recording/playback unit 40 is connected to the control unit 31. The recording/playback unit 40 is configured to record contents, such as designated programs, in a recording medium 41 and to play back the contents recorded in the recording medium 41. During recording in the recording medium 41, the recording/playback unit 40 records not only the contents, but also content information, such as information indicating title and recording time of the contents and whether corresponding contents are being recorded, is recorded in the recording medium 41 according to a request from the control unit 31.

The control unit 31 controls the transmitting/receiving unit 36 to receive a request from the DTV 10 connected by the cable 25.

The storage unit 37 connected to the control unit 31 holds program information generated by the control unit 31 based on the transmission control signal PS1 and the program sequence information SI that are received by the tuner 34 and in which the signal is processed by the decoder 35.

In the same way as the DTV 10, the DVR 30 uses the program information to create a program guide and guides the user for the programs. The program information is also used as recording reservation registration parameters in reserving of recording of a program selected by the user.

Next, an operation when the DTV 10 of the present first embodiment sets a recording reservation of the DVR 30 through the cable 25 will be described.

Recording reservation types usable in the DTV 10 and the DVR 30 of the present first embodiment include time designation reservation, in which recording is reserved based on recording reservation start time and recording time (period for executing a recording operation), and program reservation, in which recording from the start to the end of a program is reserved by determining recording reservation start time and recording reservation time in accordance with the broadcast time of the program with a designated program identifier based on the program identifiers included in the program information.

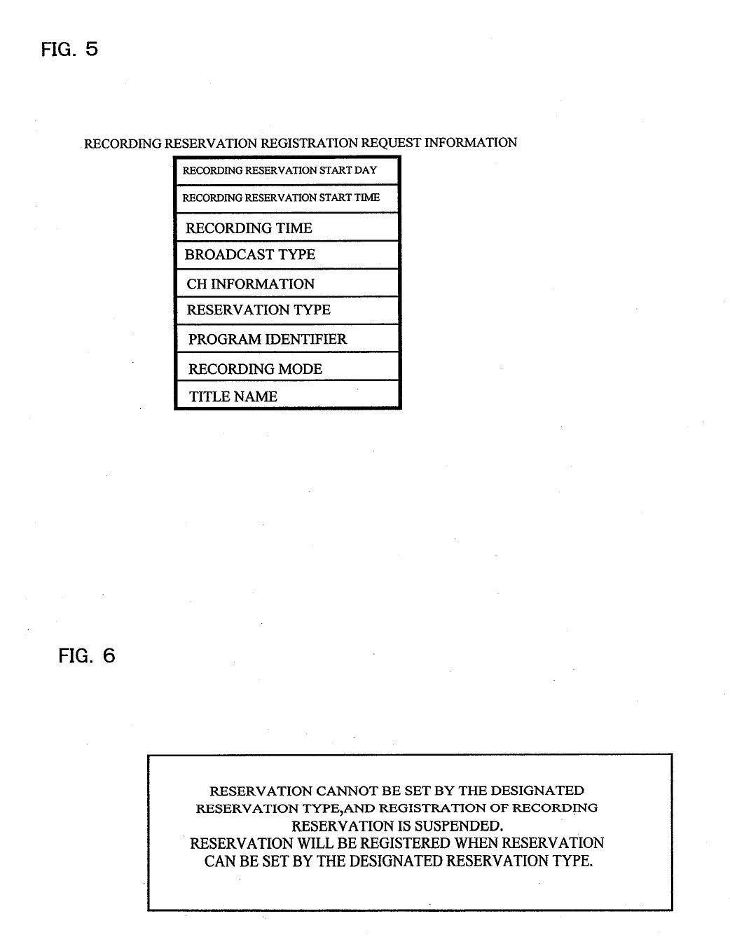

The DTV 10 sets the recording reservation of the DVR 30 by transmitting a recording reservation registration request to the DVR 30 in accordance with the recording reservation type, and FIG. 5 shows an example of parameters included in the recording reservation registration request. In the case of the time designation reservation, recording reservation start day, recording reservation start time, recording time, broadcast type such as terrestrial digital and BS digital, CH information, reservation type, recording mode, and title name of recording reservation program are used. In the case of the program reservation, a program identifier is used in addition to these.

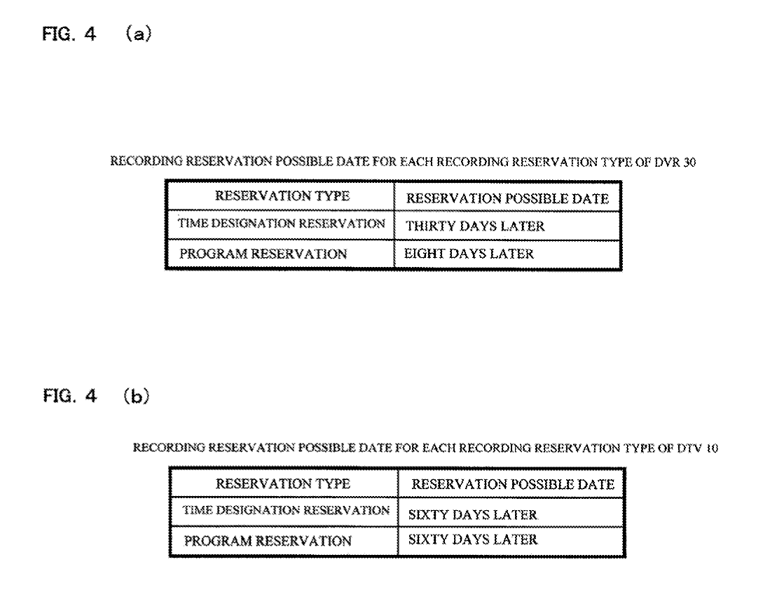

FIGS. 4(a) and 4(b) show examples of the reservation possible date for each reservation type in the DVR 30 and the DTV 10, respectively. The DVR 30 of the present first embodiment can use program information of eight days. In the case of the designation by the program reservation, the recording reservation can be set until eight days later, and in the case of the designation by the time designation reservation, the recording reservation can be set until thirty days later. Meanwhile, the DTV 10 of the present first embodiment can use program information of sixty days. In the cases of both the recording reservation types, the program reservation and the time designation reservation, a zone of time until sixty days later can be designated.

In the recording reservation registration system of the present first embodiment, although the recording reservation from the DTV 10 to the DVR 30 can be set in two types of recording reservation types, the time designation reservation and the program reservation, the case that the user sets the recording reservation of the DVR 30 by the program reservation will be described here.

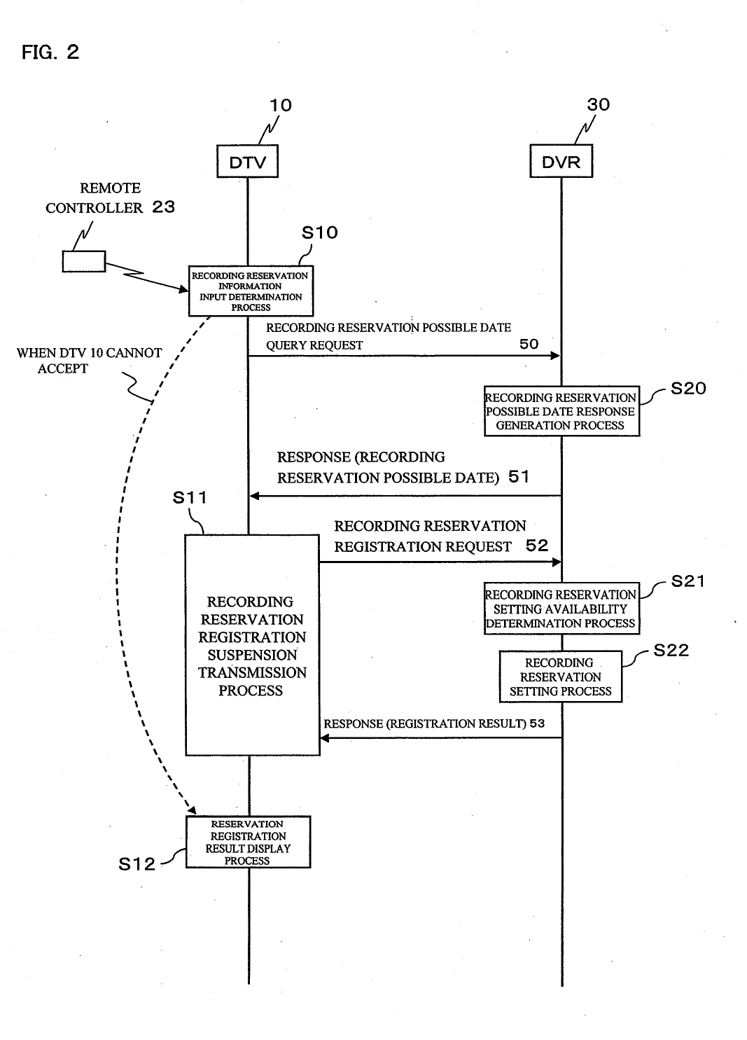

FIG. 2 shows a communication sequence when the recording reservation is set from the DTV 10 to the DVR 30 in the recording reservation registration system of the present first embodiment.

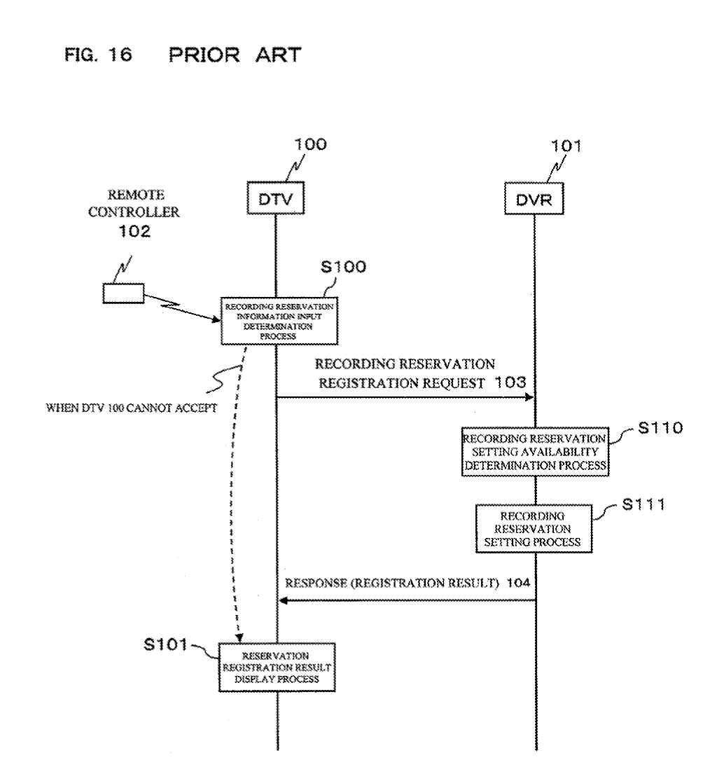

A recording reservation setting availability determination process (step S21) and a recording reservation setting process (step S22) shown in FIG. 2 are the same processes as the recording reservation setting availability determination process (step S110) and the recording reservation setting process (step S111) of the conventional recording reservation registration system shown in FIG. 16, respectively. Therefore, the DVR 30 of the present first embodiment can just be constituted by adding a function of a recording reservation possible date response generation process (step S20) to the conventional DVR 101.

First, in the DTV 10, information (recording reservation information) for which the user wants to set the reservation to the DVR 30 is inputted and determined (step S10). More specifically, the user operates the remote controller 23 to display program information acquired by the DTV 10 on the display 22 to select a program that the user desires to reserve recording and determines a recording mode and the like. The determined recording reservation information includes information indicating the recording reservation type. In this case, information indicating that the recording reservation type is the program reservation is included.

At this point, if the user inputs setting content that the DTV 10 cannot accept, “the input cannot be accepted” is displayed on the display 22 in a reservation registration result display process (step S12). For example, in the case of input by the time designation reservation, when the user inputs to designate a zone of time (for example, zone of time of seventy days later) beyond the time limit (until sixty days later) that can be designated in the DTV, “the input cannot be accepted” is displayed on the display 22.

After the recording reservation information is determined (step S10), the control unit 11 of the DTV 10 causes the transmitting/receiving unit 16 to transmit, to the DVR 30, a recording reservation possible date query request 50 for the program reservation.

For the recording reservation possible date query request 50 for the program reservation from the DTV 10, the DVR 30 generates a response 51 including the recording reservation possible date for the program reservation in the DVR 30 and transmits the response 51 to the DTV 10 (step S20). As shown in FIG. 4(a), the recording reservation possible date for the program reservation of the DVR 30 is “eight days later”. Therefore, in this case, information “recording reservation possible date is until eight days later” is included in the response 51 and transmitted.

The control unit 11 of the DTV 10 receives the response 51 for the recording reservation possible date query request 50 from the DVR 30 by the transmitting/receiving unit 16, and the control unit 11 executes a recording reservation registration suspension transmission process (step S11) based on the content of the response 51.

In this case, the transmitting/receiving unit 16 that receives the response 51 including the information of the recording reservation possible date is an example of a time limit information receiving unit of the present invention. Furthermore, the recording reservation possible date for the program reservation included in the response 51 is an example of a possible time limit of recording reservation setting of the present invention.

Next, the processing content of the recording reservation registration suspension transmission process (step S11) of the DTV 10 of the present first embodiment will be described.

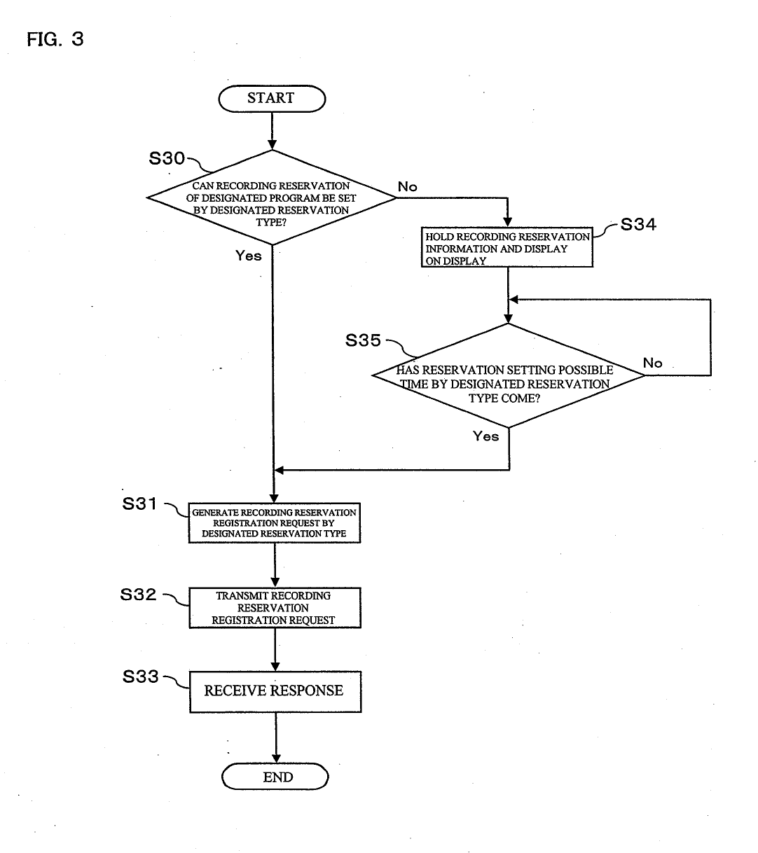

FIG. 3 shows a processing flow in the recording reservation registration suspension transmission process (step S11) of the DTV 10.

The control unit 11 first determines whether the recording reservation of the program designated for reservation recording can be set by the designated reservation type in the DVR 30, based on the response 51 for the recording reservation possible date query request 50 of FIG. 2 (step S30). The designated reservation type in this case is the program reservation. Therefore, the control unit 11 determines whether the recording reservation can be set by the program reservation in the DVR 30.

Here, a specific determination method in step S30 will be described.

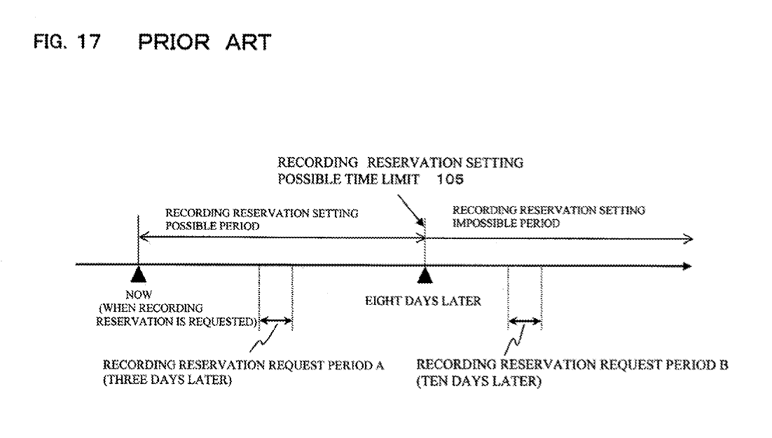

The information obtained by the response 51 is information indicating the recording reservation possible date of the DVR 30 as shown in FIG. 4(a) (information “until eight days later” for the program reservation in the present first embodiment) and is information equivalent to the recording reservation setting possible time limit 105 shown in FIG. 17.

Meanwhile, the recording reservation information designated by the user in step S10 includes information of the recording reservation start time and recording time, and the recording reservation information can specify the period (zone of time) for executing the recording process. The specified zone of time is a period equivalent to the recording reservation request period A and the recording reservation request period B shown in FIG. 17.

The control unit 11 determines “whether the recording reservation can be set in the DVR 30” based on whether the zone of time specified by the recording reservation information designated by the user is in a period before the recording reservation possible date in accordance with the recording reservation type of the DVR 30.

For example, in the present first embodiment, if the zone of time specified by the recording reservation information designated by the user is three days later, the zone of time is before the recording reservation possible date “eight days later” of the DVR 30. Therefore, the control unit 11 determines that the “recording reservation can be set”. On the other hand, for example, if the zone of time specified by the recording reservation information is ten days later, the zone of time is later than the recording reservation possible date “eight days later” of the DVR 30. Therefore, the control unit 11 determines that the “recording reservation cannot be set”.

Here, two examples will be described, in which the user designates reservation of a program in a zone of time of three days later, and the user designates reservation of a program in a zone of time of ten days later in step S10 of FIG. 2.

In the first example, when the user designates reservation of a program in a zone of time of three days later, the control unit 11 determines that the reservation can be set by the designated recording reservation type of the program reservation in step S30, generates a recording reservation registration request 52 corresponding to the program reservation of the designated reservation type (step S31), and causes the transmitting/receiving unit 16 to transmit the generated recording reservation registration request 52 to the DVR 30 (step S32).

When the transmitting/receiving unit 36 receives the recording reservation registration request 52, the DVR 30 executes similar processes as step S110 and step S111 of the conventional DVR 101 shown in FIG. 16. More specifically, when the recording reservation registration request 52 is received, the control unit 31 of the DVR 30 determines the availability to reserve recording based on the received recording reservation registration request 52, the information held by the DVR 30, and the recording reservation capability of the DVR 30 (step S21) and sets the recording reservation if the recording can be reserved (step S22). The transmitting/receiving unit 36 also returns a response 53, to the DTV 10, indicating that the recording reservation setting is completed.

The control unit 11 of the DTV 10 receives the response 53 from the DVR 30 through the transmitting/receiving unit 16 (step S33) and displays the registration result included in the received response 53 on the display 22 to notify the user (step S12).

Next, in the second example, when the user designates reservation of a program in a zone of time of ten days later, the control unit 11 determines that the reservation setting by the recording reservation type of the designated program reservation is impossible in step S30, records and holds the inputted recording reservation information in the storage unit 17, and displays that the “recording reservation will be set in a period that allows setting the recording reservation” on the display 22 to notify the user. FIG. 6 shows an example of display at this point displayed on the display 22 to notify the user.

The display 22 that displays the information of the processing result of the control unit 11 at this point is an example of a display unit of the present invention.

Subsequently, the control unit 11 checks whether the recording reservation setting possible time by the reservation type designated by the user has come (step S35). In this case, since the program reservation is designated, the control unit 11 determines whether the broadcast zone of time of the program reserved and designated by the user is in a zone of time of until eight days later.

If the reservation registration possible time by the designated reservation type has come, in other words, if the zone of time of the program reserved and designated is in a zone of time before eight days later, the control unit 11 generates the recording reservation registration request 52 from the recording reservation information held in the storage unit 17 (step S31), transmits the recording reservation registration request 52 to the DVR 30 through the transmitting/receiving unit 16 (step S32), and receives the response 53 from the DVR 30 through the transmitting/receiving unit 16 (step S33).

Then, the control unit 11 displays the registration result included in the received response 53 on the display 22 to notify the user (step S12).

In the conventional recording reservation registration system, when the recording reservation registration apparatus cannot set the recording reservation because the time is beyond the recording reservation setting possible time limit of the recording apparatus, the problem is handled by, for example, giving up the recording reservation, or instructing a recording start operation to the recording apparatus when the broadcast time of the program that the user wants to reserve recording has come. However, with such handling, there may be a problem that the recording reservation cannot be set to the recording apparatus as reservations from other recording reservation registration apparatuses are set to the recording apparatus, or that the recording reservation cannot be set due to the insufficiency of the remaining capacity of the recording apparatus as other programs are recorded.

On the other hand, in the recording reservation registration system of the present first embodiment, even if the broadcast day of the selected program is beyond the recording reservation possible time limit of the recording apparatus, the recording reservation registration apparatus (DTV 10) holds the recording reservation information. The recording reservation registration apparatus acquires recording reservation possible time limit information of the recording apparatus (DVR 30), and based on the acquired recording reservation possible time limit information, immediately sets the recording reservation when the recording reservation possible time limit comes. As a result, a failure in the recording reservation registration as other reservations are set, or a failure in the recording reservation registration due to the shortage in the remaining capacity of the recording apparatus as other reservations are set, can be prevented.

### Second Embodiment

The configuration of the recording reservation registration system of a second embodiment of the present invention is similar to the configuration of the recording reservation registration system of the first embodiment, and the block diagram is as shown in FIG. 1.

In the recording reservation registration system of the present second embodiment, the operation of the control unit 11 of the recording reservation registration apparatus (DTV 10) is different from that in the recording reservation registration system of the first embodiment.

In the first embodiment, the control unit 11 waits until the recording reservation possible date to set the recording reservation by the recording reservation type designated by the user when the recording reservation cannot be set to the DVR 30 by the recording reservation type designated by the user. Meanwhile, the control unit 11 of the present second embodiment sets the recording reservation by another recording reservation type if the recording reservation can be set by another recording reservation type when the recording reservation cannot be set to the DVR 30 by the recording reservation type designated by the user. This point is different from the first point.

In the present second embodiment, an operation of setting the recording reservation of the DVR 30 from the DTV 10 through the cable 25 will be described.

As in the first embodiment, the recording reservation types usable in the DTV 10 and the DVR 30 in the present second embodiment also include the time designation reservation and the program reservation. The parameters included in the recording reservation registration request are as shown in FIG. 5, and the reservation possible date of each recording reservation type in the DTV 10 and the DVR 30 are as shown in FIGS. 4(a) and 4(b).

The case that the user sets the recording reservation of the DVR 30 by the program reservation will be also described in the recording reservation registration system of the present second embodiment.

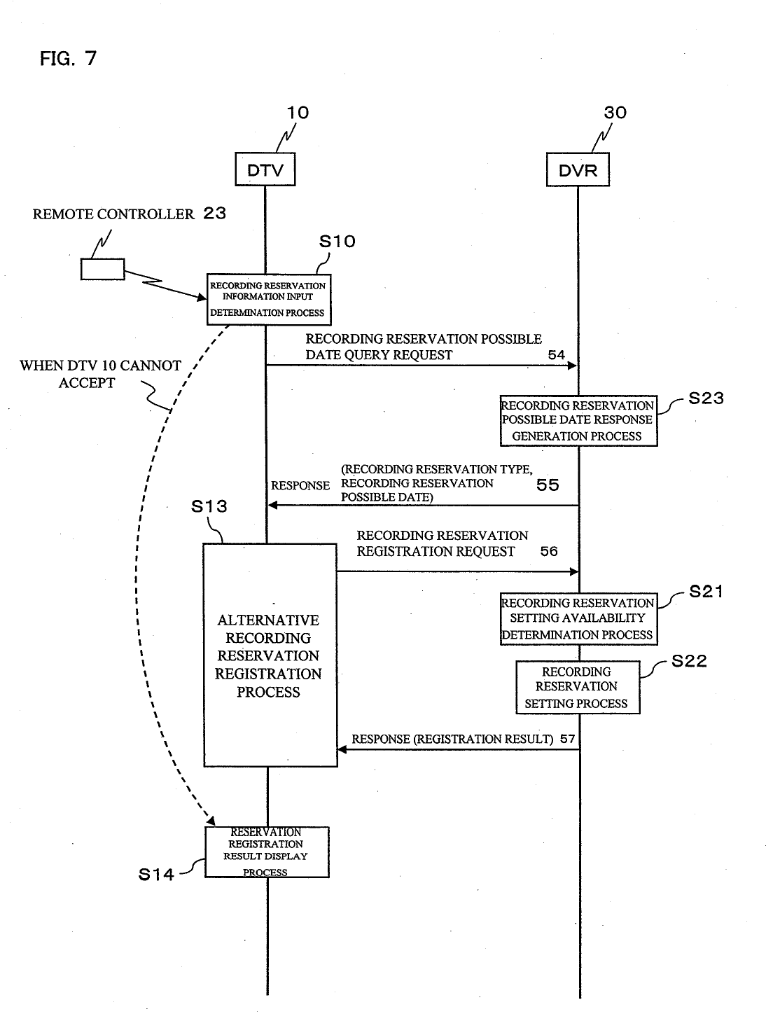

FIG. 7 shows a communication sequence when the DTV 10 sets the recording reservation to the DVR 30 in the recording reservation registration system of the present second embodiment. The parts and steps indicated by the same reference numerals as in FIG. 2 have the same functions as in FIG. 2, and the same processes are executed.

Hereinafter, parts different from the first embodiment will be described.

First, in the DTV 10, information (recording reservation information) for which the user wants to set to the DVR 30 is inputted and determined (step S10).

After the recording reservation information is determined (step S10), the control unit 11 of the DTV 10 causes the transmitting/receiving unit 16 to transmit, to the DVR 30, a recording reservation possible date query request 54 for each reservation type.

For the recording reservation possible date query request 54 for each reservation type from the DTV 10, the DVR 30 generates a response 55 including recording reservation types that the DVR 30 can execute and recording reservation possible date for each recording reservation type and transmits the response 55 to the DTV 10 (step S23).

As shown in FIG. 4(a), the recording reservation possible date for the time designation reservation of the DVR 30 is “thirty days later”, and the recording reservation possible date for the program reservation is “eight days later”. Therefore, in this case, information “recording reservation types that can be executed are time designation reservation and program reservation” and “recording reservation possible date by the time designation reservation is until thirty days later and recording reservation possible date by the program reservation is until eight days later” is included in the response 55 and transmitted.

The control unit 11 of the DTV 10 receives the response 55 for the recording reservation possible date query request 54 for each recording reservation type from the DVR 30 through the transmitting/receiving unit 16, and the control unit 11 executes an alternative recording reservation registration process (step S13) based on the content of the response 55.

Next, the processing content of the alternative recording reservation registration process (step S13) of the DTV 10 of the present second embodiment will be described.

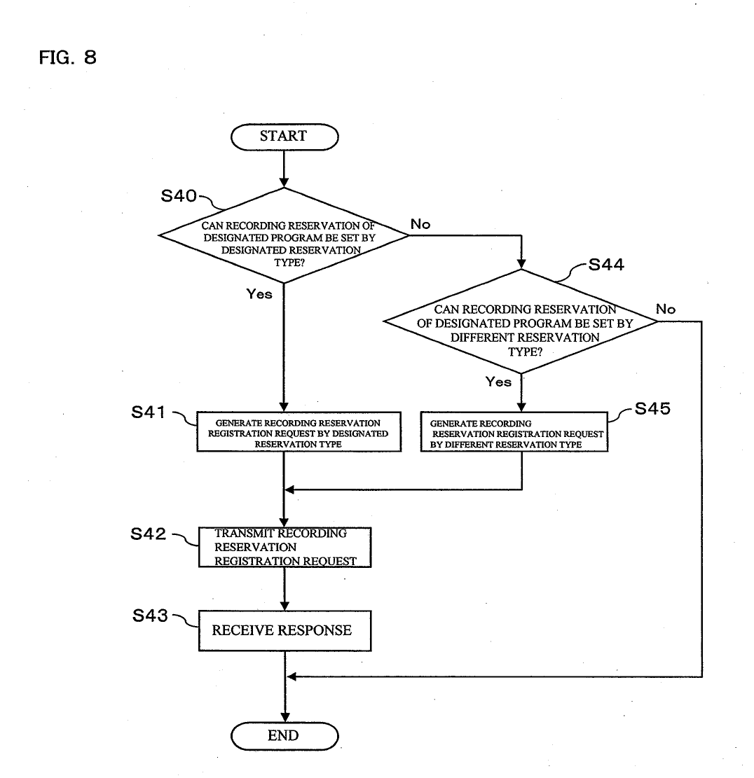

FIG. 8 shows a processing flow in the alternative recording reservation registration process (step S13) of the DTV 10.

The control unit 11 first determines whether the recording reservation of the program designated for reservation recording can be set in the DVR 30 by the designated reservation type based on the response 55 for the recording reservation possible date query request 54 of FIG. 7 (step S40). Since the designated reservation type in this case is the program reservation, the control unit 11 determines whether the recording reservation can be set by the program reservation in the DVR 30.

Here, three examples will be described, in which the user designates a reservation of a program in a zone of time of three days later, the user designates a reservation of a program in a zone of time of ten days later, and the user designates a reservation of a program in a zone of time of forty five days later, in step S10 of FIG. 7.

In the first example, when the user designates a reservation of a program in a zone of time of three days later, the designation is in a zone of time before the recording reservation possible date “eight days later” of the program reservation. Therefore, in step S40, the control unit 11 determines that the reservation can be set by the recording reservation type of the designated program reservation, generates a recording reservation registration request 56 corresponding to the program reservation which is the designated reservation type (step S41), and causes the transmitting/receiving unit 16 to transmit the generated recording reservation registration request 56 to the DVR 30 (step S42).

When the recording reservation registration request 56 is received, the control unit 31 of the DVR 30 determines the availability to reserve recording based on the received recording reservation registration request 56, information held by the DVR 30, and the recording reservation capability of the DVR 30 (step S21). If recording can be reserved, the control unit 31 sets the recording reservation (step S22), and the transmitting/receiving unit 36 returns a response 57, to the DTV 10, indicating that setting of the recording reservation is completed.

The control unit 11 of the DTV 10 then receives the response 57 from the DVR 30 through the transmitting/receiving unit 16 (step S43) and displays the registration result included in the received response 57 on the display 22 to notify the user (step S14).

Next, in the second example, when the user designates a reservation of a program in a zone of time of ten days later, the designation is in a zone of time later than the recording reservation possible date “eight days later” of the program reservation. Therefore, in step S40, the control unit 11 determines that the reservation setting by the recording reservation type of the designated program reservation is impossible and then determines whether the recording reservation of the designated program can be set in the DVR 30 by the different reservation type (step S44).

In this case, since the designated recording reservation information is by the program reservation, the control unit 11 determines whether the recording reservation can be set in the DVR 30 by the time designation reservation in step S44. The recording reservation designated by the user is in a zone of time of ten days later, and the designation is in a zone of time before the recording reservation possible date “thirty days later” of the time designation reservation. Therefore, in step S44, the control unit 11 determines that the reservation can be set by the recording reservation type of the time designation reservation.

The control unit 11 of the DTV 10 generates the recording reservation registration request 56 by the time designation reservation which is a reservation type different from the reservation type designated by the user (step S45).

The subsequent operation is the same as in the first example, in which the recording reservation registration request corresponding to the program reservation, which is the designated reservation type, is generated. The control unit 11 causes the transmitting/receiving unit 16 to transmit the generated recording reservation registration request 56 to the DVR 30 (step S42), and receives the response 57 from the DVR 30 (step S43) through the transmitting/receiving unit 16. The control unit 11 displays the registration result included in the received response 57 on the display 22 to notify the user (step S14).

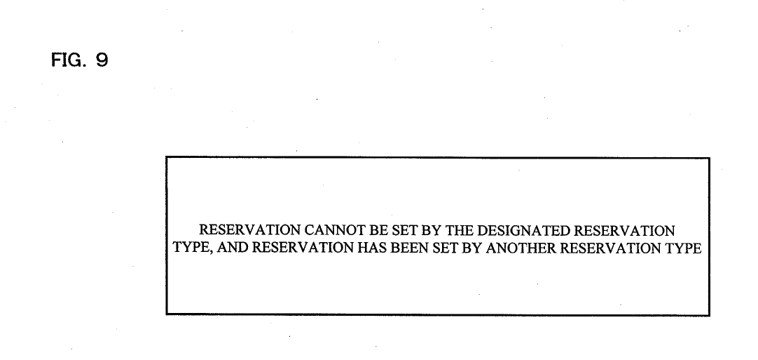

At this point, if the registration result included in the response 57 is “recording reservation setting completed”, the control unit 11 displays that “recording reservation has been set by the reservation type different from the designated reservation type” on the display 22 to notify the user in step S14. FIG. 9 shows an example of display displayed on the display 22 to notify the processing result of the control unit 11 to the user at this point.

The display 22 that displays the information of the processing result of the control unit 11 at this point is an example of a display unit of the present invention.

Next, in the third example, when the user designates a reservation of a program in a zone of time of forty five days later, the designation is in a zone of time later than the recording reservation possible date “eight days later” of the program reservation. Therefore, in step S40, the control unit 11 determines that reservation setting by the recording reservation type of the designated program reservation is impossible. Furthermore, since the designation is in a zone of time later than the recording reservation possible date “thirty days later” of the time designation reservation, the control unit 11 determines in step S44 that the reservation setting is also impossible by the reservation type of the time designation reservation.

As a result, the control unit 11 does not generate the recording reservation registration request. The control unit 11 displays that “recording reservation cannot be set” on the display (step S14) to notify the user and ends the reservation registration process.

Next, the processing content of another example of processing of the alternative recording reservation registration process (step S13) of the DTV 10 of the present second embodiment will be described.

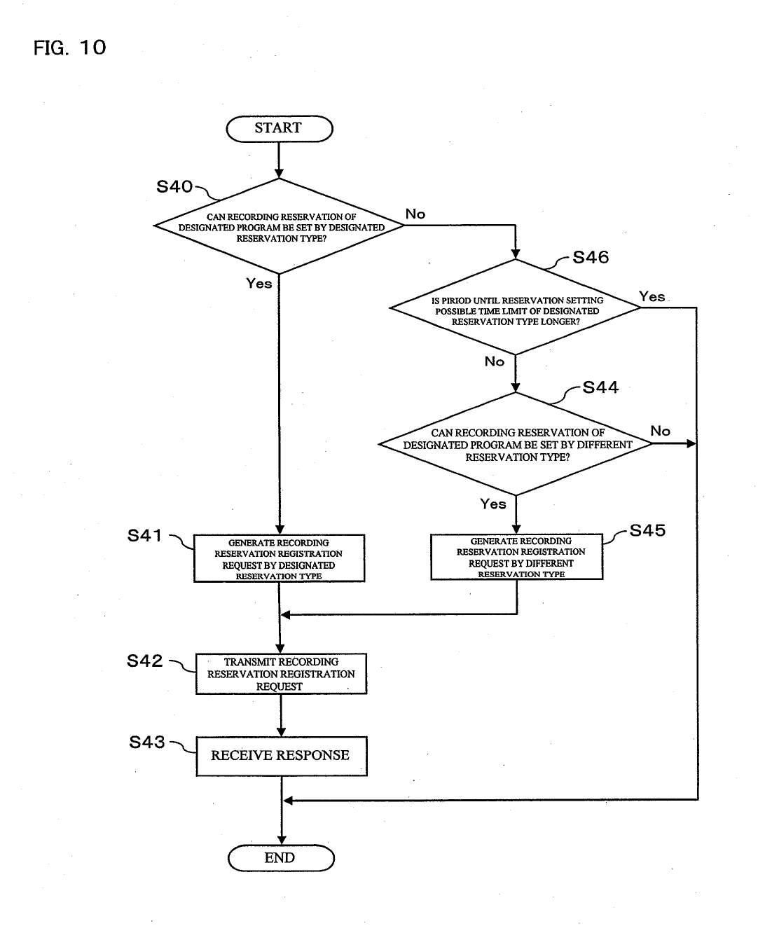

FIG. 10 shows a processing flow of another example of processing in the alternative recording reservation registration process (step S13) of the DTV 10. The same parts of processing as in FIG. 8 are shown with the same symbols. The difference is that a process of step S46 is added to the flow shown in FIG. 8.

Here, the part of processing different from the process of FIG. 8 will be described.

If the control unit 11 determines that the recording reservation cannot be set by the recording reservation type designated by the user in step S40, the control unit 11 determines whether to execute the determination process of step S44 in accordance with the reservation setting possible time limit for the recording reservation type designated by the user (step S46) before determining the availability of the recording reservation setting by the recording reservation type different from the recording reservation type designated by the user in step S44.

More specifically, in step S46, the control unit 11 compares the reservation setting possible time limits of the recording reservation type designated by the user and of the different reservation type. The control unit 11 executes the determination process to execute the process of step S44 only if a period until the reservation setting possible time limit of the different reservation type is longer and to not to execute the process of step S44 if a period until the reservation setting possible time limit of the recording reservation type designated by the user is longer.

For example, as shown in FIG. 4(a), when the period to the recording reservation possible date (thirty days later) by the time designation reservation is longer than the period to the recording reservation possible date (eight days later) of the program reservation, if the user makes a designation by the program reservation, the period to the recording reservation possible date by the different reservation type (time designation reservation) is longer. Therefore, the determination process is executed so that the process of step S44 will be executed next. On the other hand, if the user makes a designation by the time designation reservation, the period to the recording reservation possible date by the different reservation type (program reservation) is shorter in this case. Therefore, the determination process is executed so that the alternative recording reservation registration process (step S13) ends without the execution of the process of step S44.

For example, in the present second embodiment, if the user designates and inputs a zone of time of forty five days later by the time designation reservation, it is determined in step S40 that “recording reservation cannot be set by the reservation type designated by the user”. At this point, in the process shown in the flow of FIG. 8, the availability of the recording reservation setting by the program reservation, which is the reservation type different from the reservation type designated by the user, is subsequently determined (step S44). Meanwhile, in the process shown in the flow of FIG. 10, it is determined that “process of step S44 will not be executed” in step S46, and the alternative recording reservation registration process (step S13) ends without the execution of the process of step S44.

If the period until the recording reservation possible time limit of the reservation type designated by the user is longer, it is impossible to make a switch to the different reservation type to set the recording reservation. Therefore, in this case, it is meaningless to determine the availability of the recording reservation setting by the different reservation type. The process shown in the flow of FIG. 10 is configured not to execute the meaningless process of step S44, and the process can be executed more efficiently than the process shown in the flow of FIG. 8.

As described in the first embodiment, in the conventional recording reservation registration system, when the recording reservation registration apparatus cannot set the recording reservation as the reservation is beyond the recording reservation setting possible time limit of the recording apparatus, there may be a problem that the recording reservation cannot be set to the recording apparatus as reservations from other recording reservation registration apparatuses are set to the recording apparatus, or a problem that the recording reservation cannot be set due to the insufficiency of the remaining capacity of the recording apparatus as other programs are recorded.

On the other hand, in the recording reservation registration system of the present second embodiment, the recording reservation registration apparatus (DTV 10) acquires the recording reservation possible time limit information of the recording apparatus (DVR 30) and selects the recording reservation registration time and the recording reservation type based on the acquired recording reservation possible time limit information. As a result, the recording reservation setting can be executed without a failure even if the broadcast day of the selected program is beyond the recording reservation possible time limit of the recording apparatus. Furthermore, this can secure in advance the recording area necessary to record the program selected by the user in the recording apparatus. This can prevent a failure in the recording reservation registration as other reservations are set or a failure in the recording reservation registration due to the shortage in the remaining capacity of the recording apparatus as other reservation is executed.

### Third Embodiment

The configuration of the recording reservation registration system of a third embodiment of the present invention is similar to the configuration of the recording reservation registration system in the first and second embodiments, and the block diagram is as shown in FIG. 1.

In the recording reservation registration system of the present third embodiment, the operation of the control unit 11 of the recording reservation registration apparatus (DTV 10) is different from that in the recording reservation registration system of the first and second embodiments.

The control unit 11 of the present third embodiment has an advantage of a function in the first embodiment, in which the control unit 11 waits until the recording reservation possible date to set the recording reservation if the recording reservation of the program designated by the user for the DVR 30 cannot be set, and has an advantages of a function in the second embodiment, in which the control unit 11 switches to the other recording reservation type to set the recording reservation if the recording reservation cannot be set by the recording reservation type designated by the user.

In the present third embodiment, an operation of setting the recording reservation of the DVR 30 from the DTV 10 through the cable 25 will be described.

As in the first embodiment, the recording reservation types usable in the DTV 10 and the DVR 30 in the present third embodiment also include the time designation reservation and the program reservation. The parameters included in the recording reservation registration request are as shown in FIG. 5, and the reservation possible date of each recording reservation type in the DTV 10 and the DVR 30 are as shown in FIGS. 4(a) and 4(b).

The case that the user sets the recording reservation of the DVR 30 by the program reservation will be described also in the recording reservation registration system of the present third embodiment.

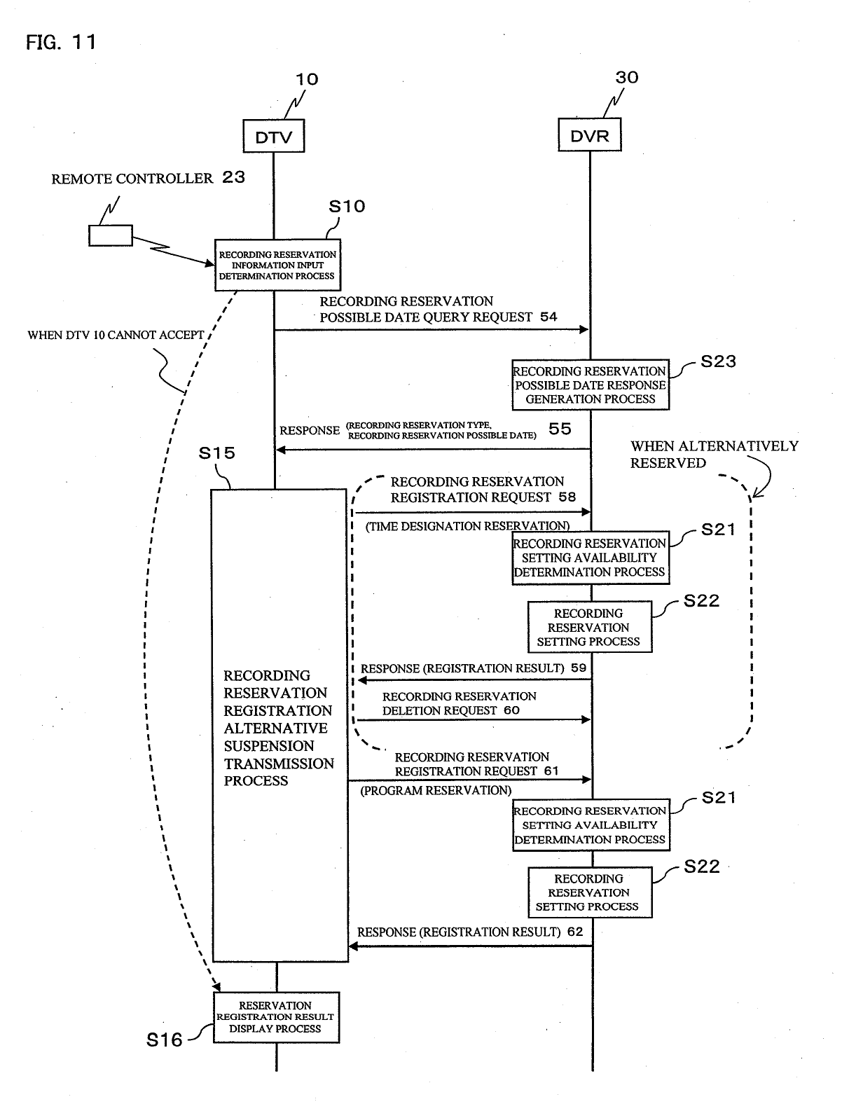

FIG. 11 shows a communication sequence when the recording reservation is set from the DTV 10 to the DVR 30 in the recording reservation registration system of the present third embodiment. The parts and steps indicated by the same reference numerals as in FIG. 7 have the same functions as in FIG. 7, and the same processes are executed.

Hereinafter, parts different from the second embodiment will be described.

After the information (recording reservation information) for which the user wants to set the reservation to the DVR 30 is inputted and determined in DTV 10 (step S10), the process until the control unit 11 of the DTV 10 receives the response 55 for the recording reservation possible date query request 54 for each recording reservation type from the DVR 30 through the transmitting/receiving unit 16 is the same as the process in the second embodiment shown in FIG. 7. Therefore, the operation after the control unit 11 receives the response 55 will be described here.

When the response 55 is received from the DVR 30, the control unit 11 of the DTV 10 executes a recording reservation registration alternative suspension transmission process (step S15) based on the content of the response 55.

Hereinafter, the processing content of the recording reservation registration alternative suspension transmission process (step S15) of the DTV 10 of the present third embodiment will be described.

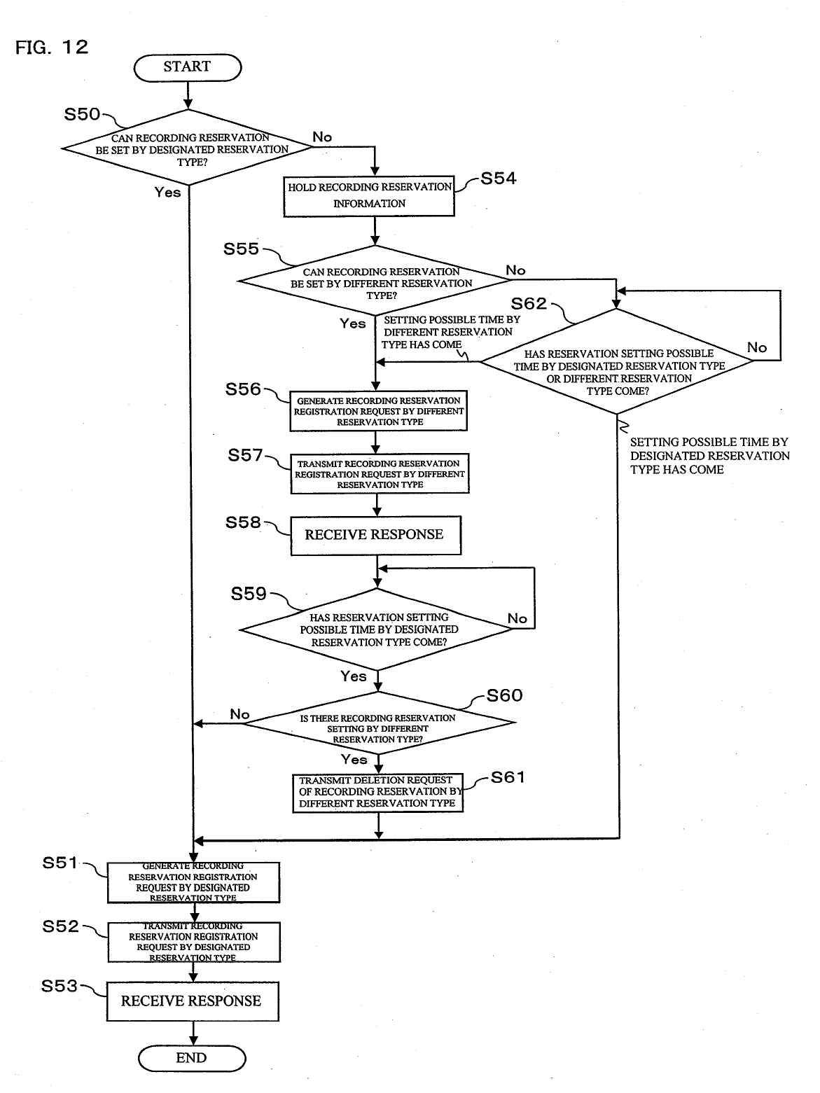

FIG. 12 shows a processing flow in the recording reservation registration alternative suspension transmission process (step S15) of the DTV 10.

The control unit 11 first determines whether the recording reservation of the program designated for reservation recording can be set in the DVR 30 by the designated reservation type based on the response 55 for the recording reservation possible date query request 54 of FIG. 11 (step S50). Since the designated reservation type in this case is the program reservation, the control unit 11 determines whether the recording reservation can be set in the DVR 30 by the program reservation.

Here, in step S10 of FIG. 11, three examples will be described, in which the user designates a reservation of a program in a zone of time of three days later, the user designates a reservation of a program in a zone of time of ten days later, and the user designates a reservation of a program in a zone of time of forty five days later.

In the first example, when the user designates a reservation of a program in a zone of time of three days later, the designation is in a zone of time before the recording reservation possible date “eight days later” of the program reservation. Therefore, the control unit 11 determines that the reservation can be set by the recording reservation type of the designated program reservation in step S50, generates a recording reservation registration request 61 corresponding to the program reservation which is the designated reservation type (step S51), and causes the transmitting/receiving unit 16 to transmit the generated recording reservation registration request 61 to the DVR 30 (step S52).

When the recording reservation registration request 61 is received, the control unit 31 of the DVR 30 determines the availability to reserve recording based on the received recording reservation registration request 61, the information held by the DVR 30, and the recording reservation capability of the DVR 30 (step S21). If recording can be reserved, the control unit 31 sets the recording reservation (step S22) and returns a response 62 from the transmitting/receiving unit 36 to the DTV 10, indicating that the recording reservation setting is completed.

The control unit 11 of the DTV 10 then receives the response 62 from the DVR 30 through the transmitting/receiving unit 16 (step S53) and displays the registration result included in the received response 62 on the display 22 to notify the user (step S16).

Next, in the second example, when the user designates a reservation of a program in a zone of time of ten days later, the designation is in a zone of time later than the recording reservation possible date “eight days later” of the program reservation. Therefore, the control unit 11 determines that the reservation setting by the recording reservation type of the designated program reservation is impossible in step S50, records and holds the recording reservation information designated by the user in the storage unit 17 (step S54), and determines whether the recording reservation of the designated program can be set in the DVR 30 by the different reservation type (step S55).

In this case, since the designated recording reservation information is by the program reservation, whether the recording reservation can be set in the DVR 30 by the time designation reservation is determined in step S55. The recording reservation designated by the user is in a zone of time of ten days later, and the designation is in a zone of time before the recording reservation possible date “thirty days later” of the time designation reservation. Therefore, the control unit 11 determines that the reservation can be set by the recording reservation type of the time designation reservation in step S55.

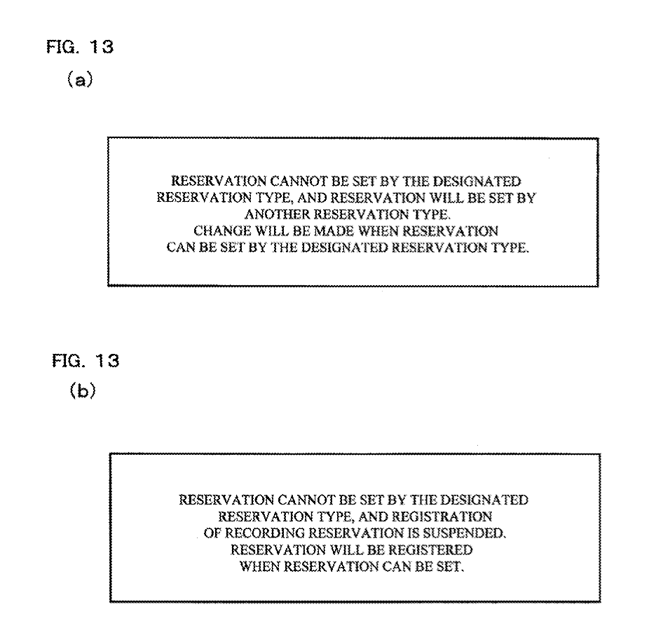

The control unit 11 of the DTV 10 generates a recording reservation registration request 58 by the time designation reservation that is the reservation type different from the reservation type designated by the user (step S56). The control unit 11 causes the transmitting/receiving unit 16 to transmit the generated recording reservation registration request 58 to the DVR 30 (step S57), and receives a response 59 from the DVR 30 through the transmitting/receiving unit 16 (step S58). The control unit 11 displays the result of processing by the control unit 11 at this point on the display 22 to notify the user. FIG. 13(a) shows an example of display displayed on the display 22 to notify the user at this point.

The display 22 that displays the information of the processing result of the control unit 11 at this point is an example of a display unit of the present invention.

Subsequently, the control unit 11 checks whether the recording reservation setting possible time by the reservation type designated by the user has come (step S59). In this case, since the user designates by the program reservation, the control unit 11 determines whether the broadcast zone of time of the reserved and designated program is in a zone of time before eight days later.

If the reservation registration possible time by the designated reservation type has come, in other words, if the zone of time of the reserved and designated program is in a zone of time before eight days later, the control unit 11 of the DTV 10 checks whether there is a recording reservation by the different reservation type, to which the reservation setting process is applied before, in the DVR 30 (step S60). The existence of the setting of the recording reservation by the different reservation type in the DVR 30 is checked by transmitting a recording reservation information acquisition request to the DVR 30 and receiving a response.

If the recording reservation by the reservation type different from the designation, to which the reservation setting process is applied before, is set in the DVR 30 in step S60, the control unit 11 generates a recording reservation deletion request 60 and causes the transmitting/receiving unit 16 to transmit the recording reservation deletion request 60 to delete the recording reservation by the different reservation type in the DVR 30 (step S61).

The control unit 11 then generates the recording reservation registration request 61 by the program reservation, which is the reservation type designated by the user, based on the recording reservation information held in the storage unit 17 (step S51), causes the transmitting/receiving unit 16 to transmit the recording reservation registration request 61 to the DVR 30 (step S52), and receives the response 62 from the DVR 30 through the transmitting/receiving unit 16 (step S53).

In step S60, if the recording reservation by the reservation type different from the designation, to which the reservation setting process is applied before, is not set in the DVR 30, the control unit 11 generates the recording reservation registration request 61 by the program reservation designated by the user and transmits the recording reservation registration request 61 to the DVR 30 without transmitting the recording reservation deletion request 60 (steps S51 and S52).

In the description above, although the existence of the setting of the recording reservation by the different reservation type in the DVR 30 is checked (step S60) before the transmission of the recording reservation deletion request 60 for the setting of the recording reservation by the different reservation type in step S61, the recording reservation deletion request 60 may be transmitted without checking the existence of the setting of the recording reservation by the different reservation type in the DVR 30 (process of step S60). In this case, for example, even if the setting of the recording reservation by the different reservation type set in step S57 is deleted by direct operation of the main body of the DVR 30 by the remote controller 42, a notification that the “designated recording reservation cannot be deleted” is just made in the response from the DVR 30 for the recording reservation deletion request 60, and there is no particular problem.

Next, in the third example, if the user designates reservation of a program in a zone of time of forty five days later, the designation is in a zone of time later than the recording reservation possible date “eight days later” of the program reservation. Therefore, the control unit 11 determines that the reservation setting by the recording reservation type of the designated program reservation is impossible in step S50. Furthermore, the designation is in a zone of time later than the recording reservation possible date “thirty days later” of the time designation reservation. Therefore, the control unit 11 determines in step S55 that the reservation setting is also impossible by the reservation type of the time designation reservation.

When the control unit 11 determines in step S55 that the reservation setting is also impossible by the different reservation type (time designation reservation), the control unit 11 displays the processing result of the control unit 11 at this point on the display 22 to notify the user. FIG. 13(b) shows an example of display displayed on the display 22 to notify the user at this point.

The control unit 11 then checks whether the recording reservation setting possible time by the designated reservation type or the recording reservation setting possible time by the different reservation type has come (step S62). More specifically, in this case, the control unit 11 determines the time at which the zone of time of the recording reservation designated by the user allows setting the recording reservation earlier between the time designation reservation and the program reservation. Thus, the control unit 11 determines whether the zone of time of the reservation recording designated by the user is within the recording reservation possible time limit of the longer period until recording reservation possible time limit.

In this case, the recording reservation possible date by the program reservation is “eight days later”, while the recording reservation possible date by the time designation reservation is “thirty days later”. Therefore, the reservation setting possible time by the time designation reservation comes first.

If the control unit 11 determines in step S62 that the zone of time of the reservation recording designated by the user has reached the time until thirty days later that allows time designation reservation, the control unit 11 then executes similar processes after step S56 as described in the second example.

Thus, the control unit 11 generates the recording reservation registration request 58 by the time designation reservation, which is the reservation type different from the reservation type designated by the user, and transmits the recording reservation registration request 58 to the DVR 30 (steps S56 and S57). Subsequently, when the recording reservation setting possible time by the program reservation has come (step S59), the control unit 11 deletes the recording reservation by the time designation reservation to which the reservation setting process is applied before (step S61) and generates and transmits the recording reservation registration request 61 by the program reservation which is the reservation type designated by the user (steps S51 and S52) to again set the reservation for the DVR 30.

In step S62, if the zone of time of the recording reservation designated by the user first reaches the reservation setting possible time by the reservation type designated by the user, the recording reservation setting by the different reservation type (steps S56 and S57) is not performed, and the recording reservation is set by the reservation type designated by the user (steps S51 and S52).

In the present third embodiment, the user sets the recording reservation by the program reservation with a shorter period until reservation possible time limit than in the time designation reservation. Therefore, in step S62, the reservation setting possible time by the different reservation type (time designation reservation) comes first. However, for example, if the user sets the recording reservation by the time designation reservation, the reservation setting possible time by the reservation type designated by the user (time designation reservation) comes first.

Next, the processing content of another example of processing of the recording reservation registration alternative suspension transmission process (step S15) of the DTV 10 of the present third embodiment will be described.

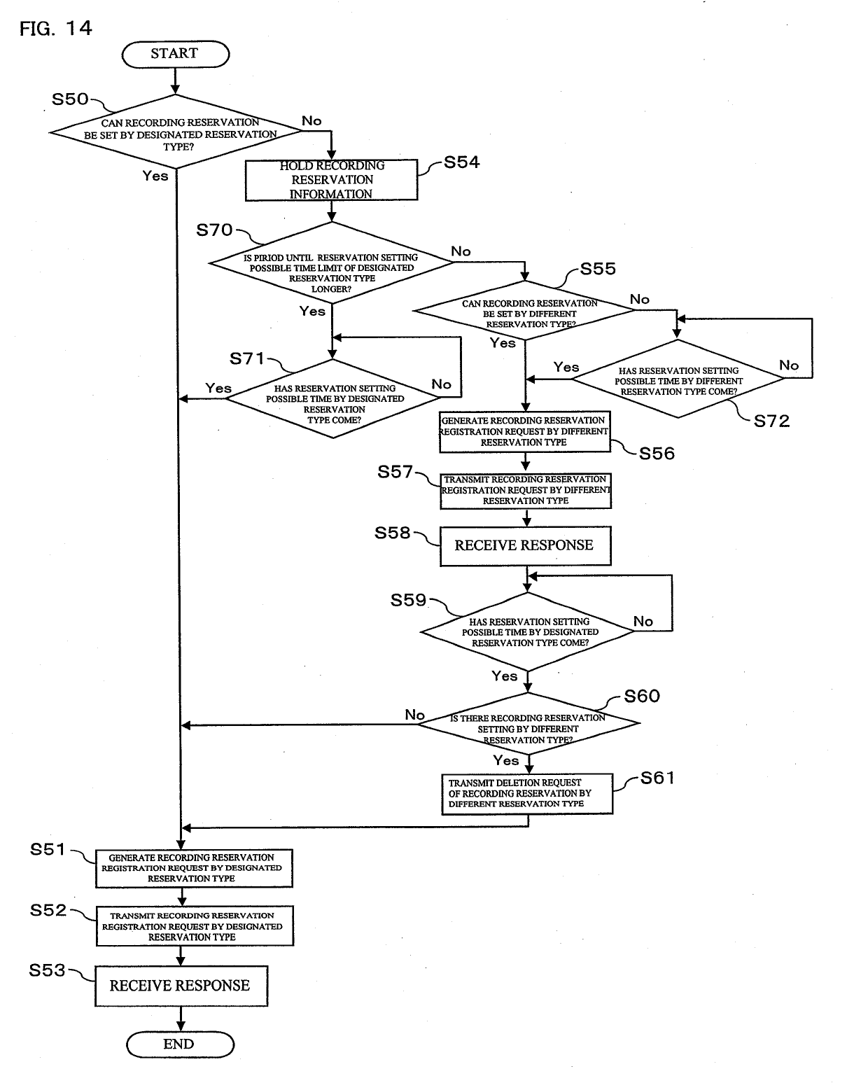

FIG. 14 shows a processing flow of another example of processing in the recording reservation registration alternative suspension transmission process (step S15) of DTV 10. The same parts of processing as in FIG. 12 are shown with the same symbols.

The differences from the flow shown in FIG. 12 are that processes of step S70 and step S71 are added and that the process of step S62 is replaced by the process of step S72.

Here, the parts of processes different from the processes of FIG. 12 will be described.

When the control unit 11 determines in step S50 that the recording reservation cannot be set by the recording reservation type designated by the user, the control unit 11 determines whether to execute the determination process of step S55 in accordance with the reservation possible setting time limit for the recording reservation type designated by the user (step S70) before determining the availability of the recording reservation setting by the recording reservation type different from the recording reservation type designated by the user in step S55.

More specifically, in step S70, the control unit 11 compares the reservation setting possible time limits of the recording reservation type designated by the user and of the different reservation type. The control unit 11 executes the determination process to execute the process of step S55 only if the period until the reservation setting possible time limit of the different reservation type is longer and to not to execute the process of step S55 if the period until the reservation setting possible time limit of the recording reservation type designated by the user is longer.

For example, as shown in FIG. 4(a), when the period until the recording reservation possible date of the time designation reservation (thirty days later) is longer than the period until the recording reservation possible date of the program reservation (eight days later), if the user designates by the program reservation, the period until the recording reservation possible date by the different reservation type (time designation reservation) is longer. Therefore, the control unit 11 executes the determination process to execute the process of step S55 next. On the other hand, if the user designates by the time designation reservation, since the period until the recording reservation possible date by the different reservation type (program reservation) is shorter in this case, the control unit 11 determines not to execute the process of step S55.

If the control unit 11 determines that the period until the reservation setting possible time limit by the recording reservation type designated by the user is longer in step S70, the control unit 11 then checks whether the recording reservation setting possible time by the designated reservation type has come (step S71). When the recording reservation setting possible time in the designated reservation type has come, the control unit 11 generates the recording reservation registration request 61 by the program reservation, which is the reservation type designated by the user, based on the recording reservation information held in the storage unit 17 (step S51), causes the transmitting/receiving unit 16 to transmit the recording reservation registration request 61 to the DVR 30 (step S52) and receives the response 62 from the DVR 30 through the transmitting/receiving unit (step S53).

For example, in the present third embodiment, if the user designates and inputs a zone of time of forty five days later in the time designation reservation, the control unit 11 determines in step S50 that the “recording reservation cannot be set by the reservation type designated by the user”. At this point, in the process shown in the flow of FIG. 12, the control unit 11 then determines the availability of the recording reservation setting by the program reservation, which is the reservation type different from the reservation type designated by the user (step S55). Meanwhile, in the process shown in the flow of FIG. 14, the control unit 11 determines that “the process of step S55 will not be executed” in step S70 and then executes the process of step S71.

If the period until the recording reservation possible time limit of the reservation type designated by the user is longer, it is impossible to make a switch to the different reservation type to set the recording reservation. Therefore, in this case, it is meaningless to determine the availability of the recording reservation setting by the different reservation type. The process shown in the flow of FIG. 14 is configured not to execute the series of meaningless processes from step S55 to step S62, and the process can be executed more efficiently than the process shown in the flow of FIG. 12.

Furthermore, in step S62 in the flow of FIG. 12, whether the zone of time that the user has reserved for recording reaches the reservation setting possible time of one of the recording reservation type designated by the user and the different reservation type is checked. On the other hand, in step S72 in the flow of FIG. 14, since the process of step S70 is added, whether the reservation setting time for the recording reservation type designated by the user has come does not have to be checked. Therefore, only whether the reservation setting possible time for the reservation type different from the recording reservation type designated by the user has come needs to be checked.

The recording reservation, registration system of the present third embodiment has an advantage of the recording reservation registration system of the second embodiment, in which an area necessary to record the program selected by the user is secured in advance, and also has an advantage that the reservation recording is executed by the recording reservation type designated by the user, in other words, by the recording setting desired by the user.

As described, in the recording reservation registration system of the embodiments, the setting of the recording reservation by the different reservation type and the suspension of the recording reservation setting as the recording reservation setting by the designated recording reservation type is impossible are displayed on the display 22. As a result, when the user attempts to set the recording reservation, even if the recording reservation is not immediately set in the recording apparatus, or the recording reservation is set by the other recording reservation type, the condition can be notified to the user. This allows the user to check the state of the recording reservation registration in the recording apparatus to prevent a wrong determination, such as the recording reservation is not set, or the recording reservation type is erroneously set.

In the embodiments, although the recording reservation registration result condition when the user performs the recording reservation registration operation is displayed on the display 22, the remote controller 23 accompanying the DTV 10 may be configured as a remote controller capable of two-way communications, and the processing result of the control unit 11 of the DTV 10 may be displayed on a liquid crystal display screen or the like of the remote controller 23 as a display unit of the present invention.

In the embodiments, as shown in FIGS. 2, 7, and 11, although it is described that the DTV 10 queries the DVR 30 for the recording reservation possible date in the recording reservation information input determination process (step S10), the DTV 10 may acquire the recording reservation possible date of the DVR 30 at other timing.

For example, when the connection with the DVR 30 is established, or when the power of the DTV 10 is turned on, the recording reservation possible date query request may be sent out just once to acquire the recording reservation possible date of the DVR 30. After that, the information of the acquired recording reservation possible date may be used without sending out the recording reservation possible date query request.

Instead of acquiring the information of the recording reservation possible date of the DVR 30 from the DVR 30, for example, the user may use the remote controller or the like 23 to input the information into the DTV 10. In this case, the DVR 30 does not have to execute the recording reservation possible date response generation process (step S20 or S23). Therefore, the conventional recording apparatus can be used as the recording apparatus of the recording reservation registration system of the embodiments.

The infrared ray receiving unit 19 in this case that receives the infrared ray emitted from the remote controller 23 to receive the information of the recording reservation possible date inputted and set by the user is an example of the time limit information input unit of the present invention.

In the embodiments, as shown in FIG. 4(a), although an example has been described in which the period until the reservation possible date by the time designation reservation is longer than the period until the reservation possible date by the program reservation, the present invention can also be applied when the period until the reservation possible date by the program reservation is longer than the period until the reservation possible date by the time designation reservation.

In this case, when a recording reservation zone of time later than the reservation possible date by the time designation reservation is designated, the reservation type is switched to the program reservation for alternative reservation. At this point, in generating the recording reservation registration request by the program reservation based on the recording reservation information by the time designation reservation, the recording reservation registration request having a program identifier, in which the recording reservation start time and the reservation recording time are the same, cannot be generated in some cases. In that case, a recording reservation registration request is generated, the request having a program identifier corresponding to a plurality of temporally consecutive programs on the same channel including all recording zones of time specified by the recording reservation information by the designated time designation reservation. In this way, a zone of time necessary to execute recording for the recording reservation information by the designated time designation reservation can be secured by generating a plurality of temporally consecutive recording reservation registration requests.

In the embodiments, although the possible time limit of the recording reservation setting of the recording apparatus is a time limit determined by a relative time from the time that the DVR 30 receives the recording reservation possible date query request from the DTV 10 as shown in FIG. 4(a), the time limit may be determined by an absolute time, such as “until X month, Y day”.

In the embodiments, although whether the reservation registration possible time by the designated reservation type or the recording reservation setting possible time by the different reservation type has come is checked, the possible time denotes a period, not a moment. When the reservation registration possible time or the recording reservation setting possible time by the different reservation type has come, if the power of the recording apparatus is turned off, or if the request from the recording reservation registration apparatus cannot be accepted as the recording apparatus is in operation, it is desired to transmit the request again after a predetermined time. Even in such a case, it is desired to transmit the request every predetermined time at early points to secure the recording area necessary to record the program selected by the user in the recording apparatus at early points.

In the embodiments, although each of the DTV 10 and the DVR 30 is configured to hold the tuner 14 as a broadcast receiving instrument, the configuration is not limited to this.

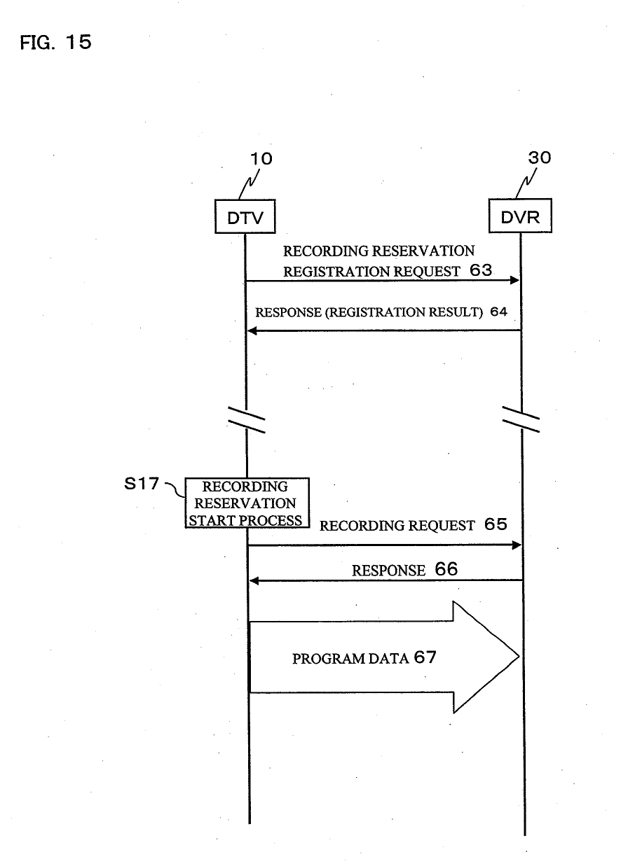

FIG. 15 shows a communication sequence for setting the recording reservation and requesting recording from the DTV 10 to the DVR 30 in the recording reservation registration system comprising the DTV 10 that transmits a recording request and program data.

The present invention can also be applied to a configuration as shown in FIG. 15, in which the DTV 10 transmits, to the DVR 30, not only a recording reservation registration request 63, but also a recording request 65 and program data 67 to be recorded. In this case, the DVR 30 can realize the program recording without holding the tuner 14.

In this case, the DTV 10 holds the recording reservation information designated by the user after the completion of the recording reservation registration 63 to the DVR 30. Based on the recording reservation information, when the recording start time is close, the DTV 10 transmits the recording request 65 to the DVR 30 and transmits the program data 67 from the point equivalent to the recording start time. The DTV 10 continues transmitting the program data 67 for the time equivalent to the recording reservation period and ends transmitting the program data 67 at the end of the recording reservation period.

Meanwhile, based on the recording reservation information registered in advance, the DVR 30 receives and records the program data 67 transmitted from the DTV 10. The DVR 30 will perform an operation, such as recording all program data 67 transmitted from DTV 10, or recording the program data for the time equivalent to the recording reservation time from the recording reservation start time among the received data when the recording is reserved by the time designation, or recording only the program data having a program identifier designated at the recording reservation registration among the received data when the program reservation is designated.

In this case, the DTV 10 may transmit, to the DVR 30, the program data of a period from a little before the recording start time to a little after the recording end time to prevent the missed top or missed bottom of the program in the recording.

In the embodiments, although the DTV 10 executes a process of holding the recording reservation information, or a process of switching to the different reservation type for reservation and setting when the recording reservation cannot be set to the DVR 30, the same advantage can be attained when the DVR 30 executes the processes in the DTV 10 described in the embodiments.

For the DVR 30 to execute the processes, for example, even if the recording reservation registration information transmitted from the DTV 10 is beyond the recording reservation possible date of the DVR 30, the request is acquired without rejection, and the request is held until the recording reservation possible date. The recording reservation of the DVR 30 can be set when the recording reservation setting possible time has come. When the reservation can be set by switching to the different reservation type, the DVR 30 can execute a process of setting the reservation by the different recording reservation type based on the recording reservation registration information received from the DTV 10.

In this way, when the DVR 30 executes the processes, the conventional recording reservation registration apparatus can be used as the recording reservation registration apparatus of the recording reservation registration system of the embodiments.

In addition, the program of the present invention is a program for causing a computer to execute the operations of the control step of comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus, of the above-described recording reservation registration method of the present invention and is a program which operates in cooperation with the computer.

Moreover, the recording medium of the present invention is a recording medium having recorded thereon a program for causing a computer to execute the control step of comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus, of the above-described recording reservation registration method of the present invention and is a computer-readable recording medium, the program of which, when read, is used in cooperation with the computer.

Moreover, the program of the present invention is a program for causing a computer to execute the operations of the control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus, of the above-described recording reservation registration method of the present invention and is a program which operates in cooperation with the computer.

Moreover, the recording medium of the present invention is a recording medium having recorded thereon a program for causing a computer to execute the control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus, of the above-described recording reservation registration method of the present invention and is a computer-readable recording medium, the program of which, when read, is used in cooperation with the computer.

Moreover, the program of the present invention is a program for causing a computer to execute the operations of the control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus, of the above-described recording reservation registration method of the present invention and is a program which operates in cooperation with the computer.

Moreover, the recording medium of the present invention is a recording medium having recorded thereon a program for causing a computer to execute the control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus, of the above-described recording reservation registration method of the present invention and is a computer-readable recording medium, the program of which, when read, is used in cooperation with the computer.

Moreover, the above-mentioned “operation of the control step” of the present invention means the operation of all or a part of the control step.

In addition, one utilizing form of the program of the present invention may be an aspect of being recorded on a recording medium, ROM and the like are included, which can be read by a computer, and operating with collaborating with the computer.

Moreover, one utilizing form of the program of the present invention may be an aspect of being transmitted inside a transmission medium, transmission media such as the Internet, light, and radio waves and the like are included, being read by a computer, and operating with collaborating with the computer.

Furthermore, a computer according to the present invention described above is not limited to pure hardware such as a CPU and may be arranged to include firmware, an OS and, furthermore, peripheral devices.

Moreover, as described above, configurations of the present invention may either be realized through software or through hardware.

### INDUSTRIAL APPLICABILITY

A recording reservation registration system, recording reservation registration apparatus, a recording reservation registration method, and the like of the present invention have an advantage of allowing reservation recording beyond a recording reservation setting possible time limit of recording apparatus and are useful as a recording reservation registration system, a recording reservation registration apparatus, a recording reservation registration method, and the like constituted by a recording reservation registration apparatus that uses program information of a selected program to request the recording apparatus connected through a network to register the recording reservation and a recording apparatus that sets the recording reservation in accordance with the recording reservation registration request from the recording reservation registration apparatus to reserve recording.

### DESCRIPTION OF SYMBOLS

10 DTV

11 control unit

12 reception buffer

13 antenna

14 tuner

15 decoder

16 transmitting/receiving unit

17 storage unit

18 non-volatile memory

19 infrared ray receiving unit

20 video display unit

21 speaker

22 display

23 remote controller

25 cable

30 DVR

31 control unit

32 buffer

33 antenna

34 tuner

35 decoder

36 transmitting/receiving unit

37 storage unit

38 non-volatile memory

39 infrared ray receiving unit

40 recording/playback unit

41 recording medium

42 remote controller

50 recording reservation possible date query request

51 response

52 recording reservation registration request

53 response

54 recording reservation possible date query request

55 response

56 recording reservation registration request

57 response

58 recording reservation registration request

59 response

60 recording reservation deletion request

61 recording reservation registration request

62 response

63 recording reservation registration request

64 response

65 recording request

66 response

67 program data

1. A recording reservation registration system comprising:
a recording reservation registration apparatus that transmits a recording reservation registration request of a program to be broadcasted; and
a recordable recording apparatus that receives the recording reservation registration request to set a recording reservation in accordance with the recording reservation registration request,
the recording reservation registration apparatus comprising:
a reservation information input unit that inputs recording reservation information of a program to be reserved for recording into the recording apparatus;
a control unit that compares a zone of time specified by the inputted recording reservation information and a possible time limit of recording reservation setting of the recording apparatus, generates the recording reservation registration request from the recording reservation information when the recording reservation can be set in the recording apparatus, holds the recording reservation information until the recording reservation can be set in the recording apparatus when the recording reservation cannot be set in the recording apparatus, and generates the recording reservation registration request from the held recording reservation information when the recording reservation becomes capable to be set in the recording apparatus; and
a reservation information transmitting unit that transmits the recording reservation registration request generated by the control unit to the recording apparatus.

2. A recording reservation registration apparatus that transmits a recording reservation registration request to a recordable recording apparatus which receives the recording reservation registration request of a program to be broadcasted and sets a recording reservation in accordance with the recording reservation registration request,
the recording reservation registration apparatus comprising:
a reservation information input unit that inputs recording reservation information of a program to be reserved for recording into the recording apparatus;
a control unit that compares a zone of time specified by the inputted recording reservation information and a possible time limit of recording reservation setting of the recording apparatus, generates the recording reservation registration request from the recording reservation information when the recording reservation can be set in the recording apparatus, holds the recording reservation information until the recording reservation can be set in the recording apparatus when the recording reservation cannot be set in the recording apparatus, and generates the recording reservation registration request from the held recording reservation information when the recording reservation becomes capable to be set in the recording apparatus; and
a reservation information transmitting unit that transmits the recording reservation registration request generated by the control unit to the recording apparatus.

3. A recording reservation registration system comprising:
a recording reservation registration apparatus that transmits a recording reservation registration request of a program to be broadcasted; and
a recordable recording apparatus that receives the recording reservation registration request to set a recording reservation in accordance with the recording reservation registration request, wherein
there are two types of the recording reservations, and possible time limits of recording reservation setting of the recording reservations are different to each other,
the recording reservation registration apparatus comprising:
a reservation information input unit that inputs recording reservation information including information of a recording reservation type, of a program to be reserved for recording into the recording apparatus;
a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generates a recording reservation registration request corresponding to the different recording reservation type from the inputted recording reservation information when the recording reservation can be set by the different recording reservation type in the recording apparatus; and
a reservation information transmitting unit that transmits the recording reservation registration request generated by the control unit to the recording apparatus.

4. A recording reservation registration apparatus that transmits a recording reservation registration request to a recordable recording apparatus which receives the recording reservation registration request of a program to be broadcasted and sets a recording reservation in accordance with the recording reservation registration request, wherein
there are two types of the recording reservations, and possible time limits of recording reservation setting of the recording reservations are different to each other,
the recording reservation registration apparatus comprising:
a reservation information input unit that inputs recording reservation information including information of a recording reservation type, of a program to be reserved for recording into the recording apparatus;
a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generates a recording reservation registration request corresponding to the different recording reservation type from the inputted recording reservation information when the recording reservation can be set by the different recording reservation type in the recording apparatus; and
a reservation information transmitting unit that transmits the recording reservation registration request generated by the control unit to the recording apparatus.

5. The recording reservation registration apparatus according to claim 4, wherein
the control unit holds the inputted recording reservation information until the recording reservation can be set by the recording reservation type with a longer period until possible time limit in the recording apparatus when the recording reservation cannot be set by the different recording reservation type in the recording apparatus and generates a recording reservation registration request corresponding to the recording reservation type with the longer period until possible time limit from the held recording reservation information when the recording reservation becomes capable to be set.

6. The recording reservation registration apparatus according to claim 5, wherein
when the recording reservation type with the period until longer possible time limit is not the recording reservation type of the inputted recording reservation information, after generating the recording reservation registration request corresponding to the recording reservation type with the longer period until possible time limit, the control unit generates a recording reservation registration request corresponding to the recording reservation type of the inputted recording reservation information and a cancellation instruction of the recording reservation set by the recording reservation registration request of the recording reservation type with the longer period until possible time limit when the recording reservation becomes capable to be set by the recording reservation type with a shorter period until possible time limit, and
the reservation information transmitting unit transmits, to the recording apparatus, the cancellation instruction of the recording reservation generated by the control unit and the recording reservation registration request corresponding to the recording reservation type of the inputted recording reservation information.

7. A recording reservation registration system comprising:
a recording reservation registration apparatus that transmits a recording reservation registration request of a program to be broadcasted; and
a recordable recording apparatus that receives the recording reservation registration request to set a recording reservation in accordance with the recording reservation registration request, wherein
there are two types of the recording reservations, and possible time limits of recording reservation setting of the recording reservations are different to each other,
the recording reservation registration apparatus comprising:
a reservation information input unit that inputs recording reservation information including information of a recording reservation type, of a program to be reserved for recording into the recording apparatus;
a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generates a recording reservation registration request corresponding to the different recording reservation type from the inputted recording reservation information when the recording reservation can be set by the different recording reservation type in the recording apparatus; and
a reservation information transmitting unit that transmits the recording reservation registration request generated by the control unit to the recording apparatus.

8. A recording reservation registration apparatus that transmits a recording reservation registration request to a recordable recording apparatus which receives the recording reservation registration request of a program to be broadcasted and sets a recording reservation in accordance with the recording reservation registration request, wherein
there are two types of the recording reservations, and possible time limits of recording reservation setting of the recording reservations are different to each other,
the recording reservation registration apparatus comprising:
a reservation information input unit that inputs recording reservation information including information of a recording reservation type, of a program to be reserved for recording into the recording apparatus;
a control unit that compares a zone of time specified by the inputted recording reservation information and a possible time limit corresponding to the recording reservation type of the recording reservation information between the two possible time limits of recording reservation setting of the recording apparatus, generates a recording reservation registration request corresponding to the recording reservation type of the recording reservation information when the recording reservation can be set in the recording apparatus, further compares the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generates a recording reservation registration request corresponding to the different recording reservation type from the inputted recording reservation information when the recording reservation can be set by the different recording reservation type in the recording apparatus; and
a reservation information transmitting unit that transmits the recording reservation registration request generated by the control unit to the recording apparatus.

9. The recording reservation registration apparatus according to claim 4, wherein
the control unit holds the inputted recording reservation information until the recording reservation can be set in the recording apparatus by the recording reservation type of the inputted recording reservation information when the recording reservation cannot be set by the different recording reservation type in the recording apparatus and generates a recording reservation registration request corresponding to the recording reservation type of the held recording reservation information when the recording reservation becomes capable to be set.

10. The recording reservation registration apparatus according to claim 4, wherein
the two types of recording reservations include time designation reservation set by a zone of time with an absolute time and program reservation set based on a program identifier included in program information, and
when generating a recording reservation registration request corresponding to the program reservation from the recording reservation information inputted by the time designation reservation, the control unit generates the recording reservation registration request corresponding to one or a plurality of consecutive programs including the zone of time specified by the inputted recording reservation information.

11. The recording reservation registration apparatus according to claim 8, wherein
the control unit holds the inputted recording reservation information until the recording reservation can be set in the recording apparatus by the recording reservation type of the inputted recording reservation information when the recording reservation cannot be set in the recording apparatus by the recording reservation type of the inputted recording reservation information and when the period until the possible time limit corresponding to the recording reservation type different from the recording reservation type of the recording reservation information is shorter than the period until the possible time limit of the recording reservation type of the recording reservation information and generates a recording reservation registration request corresponding to the recording reservation type of the held recording reservation information when the recording reservation becomes capable to be set.

12. The recording reservation registration apparatus according to claim 8, wherein
the control unit holds the inputted recording reservation information until the recording reservation can be set by the different recording reservation type in the recording apparatus when the recording reservation cannot be set by the different recording reservation type in the recording apparatus and generates a recording reservation registration request corresponding to the different recording reservation type from the held recording reservation information when the recording reservation becomes capable to be set.

13. The recording reservation registration apparatus according to claim 12, wherein
after generating the recording reservation registration request corresponding to the different recording reservation type, when the recording reservation becomes capable to be set by the recording reservation type of the inputted recording reservation information, the control unit generates a recording reservation registration request corresponding to the recording reservation type of the inputted recording reservation information and a cancellation instruction of the recording reservation set by the recording reservation registration request of the different recording reservation type, and
the reservation information transmitting unit transmits, to the recording apparatus, the cancellation instruction of the recording reservation generated by the control unit and the recording reservation registration request corresponding to the recording reservation type of the inputted recording reservation information.

14. The recording reservation registration apparatus according to claim 2, wherein
the zone of time specified by the recording reservation information is a zone of time determined by an absolute time or a zone of time determined by a program identifier included in program information, and
the possible time limit of recording reservation setting is defined as a time limit determined by an absolute time or a time limit determined by a relative time from when the recording apparatus receives the recording reservation registration request.

15. The recording reservation registration apparatus according to claim 2, comprising
a time limit information input unit for a user to input a possible time limit of recording reservation setting of the recording apparatus.

16. The recording reservation registration apparatus according to claim 2, comprising
a time limit information receiving unit that acquires information of the possible time limit of recording reservation setting from the recording apparatus.

17. The recording reservation registration apparatus according to claim 16, wherein
the time limit information receiving unit acquires the information of the possible time limit of recording reservation setting from the recording apparatus every time the zone of time specified by the inputted recording reservation information is compared or acquires the information from the recording apparatus in advance.

18. The recording reservation registration apparatus according to claim 2, comprising
a display unit that displays a processing result by the control unit.

19. A recording reservation registration method of a recording reservation registration apparatus that transmits a recording reservation registration request of a program to be broadcasted to a recordable recording apparatus that receives the recording reservation registration request to set a recording reservation in accordance with the recording reservation registration request,
the recording reservation registration method comprising:
a reservation information input step of inputting recording reservation information of a program to be reserved for recording into the recording apparatus;
a control step of comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus; and
a reservation information transmission step of transmitting the recording reservation registration request generated in the control step to the recording apparatus.

20. A recording reservation registration method of a recording reservation registration apparatus that transmits a recording reservation registration request of a program to be broadcasted to a recordable recording apparatus that receives the recording reservation registration request to set a recording reservation in accordance with the recording reservation registration request, wherein
there are two types of the recording reservations, and possible time limits of recording reservation setting of the recording reservations are different to each other,
the recording reservation registration method comprising:
a reservation information input step of inputting recording reservation information including information of a recording reservation type, of a program to be reserved for recording into the recording apparatus;
a control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus; and
a reservation information transmission step of transmitting the recording reservation registration request generated in the control step to the recording apparatus.

21. A recording reservation registration method of a recording reservation registration apparatus that transmits a recording reservation registration request of a program to be broadcasted to a recordable recording apparatus that receives the recording reservation registration request to set a recording reservation in accordance with the recording reservation registration request, wherein
there are two types of the recording reservations, and possible time limits of recording reservation setting of the recording reservations are different to each other,
the recording reservation registration method comprising:
a reservation information input step of inputting recording reservation information including information of a recording reservation type, of a program to be reserved for recording into the recording apparatus;
a control step of comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus; and
a reservation information transmission step of transmitting the recording reservation registration request generated in the control step to the recording apparatus.

22. A program causing a computer to execute the control step of the recording reservation registration method according to claim 19, the control step comprising comparing a zone of time specified by the inputted recording reservation information and a possible time limit of recording reservation setting of the recording apparatus, generating the recording reservation registration request from the recording reservation information when the recording reservation can be set in the recording apparatus, holding the recording reservation information until the recording reservation can be set in the recording apparatus when the recording reservation cannot be set in the recording apparatus, and generating the recording reservation registration request from the held recording reservation information when the recording reservation becomes capable to be set in the recording apparatus.

23. A program causing a computer to execute the control step of the recording reservation registration method according to claim 20, the control step comprising comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information between the two possible time limits of recording reservation setting of the recording apparatus when the recording reservation cannot be set in the recording apparatus, and generating a recording reservation registration request corresponding to the different recording reservation type from the inputted recording reservation information when the recording reservation can be set by the different recording reservation type in the recording apparatus.

24. A program causing a computer to execute the control step of the recording reservation registration method according to claim 21, the control step comprising comparing a zone of time specified by the inputted recording reservation information and a possible time limit corresponding to the recording reservation type of the recording reservation information between the two possible time limits of recording reservation setting of the recording apparatus, generating a recording reservation registration request corresponding to the recording reservation type of the recording reservation information when the recording reservation can be set in the recording apparatus, further comparing the zone of time specified by the inputted recording reservation information and a possible time limit corresponding to the recording reservation type different from the recording reservation type of the recording reservation information when the recording reservation cannot be set in the recording apparatus and when a period until the possible time limit corresponding to the different recording reservation type is longer than a period until the possible time limit of the recording reservation type of the recording reservation information, and generating a recording reservation registration request corresponding to the different recording reservation type from the inputted recording reservation information when the recording reservation can be set by the different recording reservation type in the recording apparatus.

25. A recording medium that can be processed by a computer, the recording medium recording the program according to claim 22.

26. The recording reservation registration apparatus according to claim 8, wherein
the control unit holds the inputted recording reservation information until the recording reservation can be set in the recording apparatus by the recording reservation type of the inputted recording reservation information when the recording reservation cannot be set by the different recording reservation type in the recording apparatus and generates a recording reservation registration request corresponding to the recording reservation type of the held recording reservation information when the recording reservation becomes capable to be set.

27. The recording reservation registration apparatus according to claim 8, wherein
the two types of recording reservations include time designation reservation set by a zone of time with an absolute time and program reservation set based on a program identifier included in program information, and
when generating a recording reservation registration request corresponding to the program reservation from the recording reservation information inputted by the time designation reservation, the control unit generates the recording reservation registration request corresponding to one or a plurality of consecutive programs including the zone of time specified by the inputted recording reservation information.

28. The recording reservation registration apparatus according to claim 4, wherein
the zone of time specified by the recording reservation information is a zone of time determined by an absolute time or a zone of time determined by a program identifier included in program information, and
the possible time limit of recording reservation setting is defined as a time limit determined by an absolute time or a time limit determined by a relative time from when the recording apparatus receives the recording reservation registration request.

29. The recording reservation registration apparatus according to claim 8, wherein
the zone of time specified by the recording reservation information is a zone of time determined by an absolute time or a zone of time determined by a program identifier included in program information, and
the possible time limit of recording reservation setting is defined as a time limit determined by an absolute time or a time limit determined by a relative time from when the recording apparatus receives the recording reservation registration request.

30. The recording reservation registration apparatus according to claim 4, comprising
a time limit information input unit for a user to input a possible time limit of recording reservation setting of the recording apparatus.

31. The recording reservation registration apparatus according to claim 8, comprising
a time limit information input unit for a user to input a possible time limit of recording reservation setting of the recording apparatus.

32. The recording reservation registration apparatus according to claim 4, comprising
a time limit information receiving unit that acquires information of the possible time limit of recording reservation setting from the recording apparatus.

33. The recording reservation registration apparatus according to claim 8, comprising
a time limit information receiving unit that acquires information of the possible time limit of recording reservation setting from the recording apparatus.

34. The recording reservation registration apparatus according to claim 32, wherein
the time limit information receiving unit acquires the information of the possible time limit of recording reservation setting from the recording apparatus every time the zone of time specified by the inputted recording reservation information is compared or acquires the information from the recording apparatus in advance.

35. The recording reservation registration apparatus according to claim 33, wherein
the time limit information receiving unit acquires the information of the possible time limit of recording reservation setting from the recording apparatus every time the zone of time specified by the inputted recording reservation information is compared or acquires the information from the recording apparatus in advance.

36. The recording reservation registration apparatus according to claim 4, comprising
a display unit that displays a processing result by the control unit.

37. The recording reservation registration apparatus according to claim 8, comprising
a display unit that displays a processing result by the control unit.

38. A recording medium that can be processed by a computer, the recording medium recording the program according to claim 23.

39. A recording medium that can be processed by a computer, the recording medium recording the program according to claim 24.
